(19) United States
(12) Patent Application Publication
(10) Pub. No.: US 2021/0087498 A1
(43) Pub. Date: Mar. 25, 2021

(54) DETERGENT COMPOSITION

(71) Applicant: The Procter & Gamble Company, Cincinnati, OH (US)

(72) Inventors: Jean-Luc Philippe BETTIOL, Etterbeek (BE); Denis Alfred GONZALES, Brussels (BE); Juan Esteban VELASQUEZ, Cincinnati, OH (US); Nicholas William GEARY, Mariemont, OH (US)

(21) Appl. No.: 17/111,537

(22) Filed: Dec. 4, 2020

Related U.S. Application Data
(63) Continuation of application No. 16/188,615, filed on Nov. 13, 2018, now abandoned.

(30) Foreign Application Priority Data
Nov. 13, 2017 (EP) 17201300.5
Jun. 20, 2018 (EP) 18178709.4

(51) Int. Cl. C11D 3/386; C11D 1/94; C11D 11/00; C11D 9/26; C11D 9/40

(52) U.S. Cl. CPC C11D 3/386; C11D 1/94; C11D 3/38654; C11D 1/12; C11D 9/267; C11D 9/40; C11D 11/0023

(57) ABSTRACT

A detergent composition, preferably a manual dishwashing detergent composition, including one or more diol synthases capable of converting one or more unsaturated fatty acids into one or more oxylipins, and a surfactant system including one or more anionic surfactants and one or more co-surfactants selected from the group consisting of amphoteric surfactant, zwitterionic surfactant, and mixtures thereof. Method of using the detergent composition including a surfactant system and the diol synthases are also provided.

### REFERENCE TO A SEQUENCE LISTING

This application contains a Sequence Listing in computer readable form. The computer readable form is incorporated herein by reference.

### FIELD OF THE INVENTION

The present invention relates to a detergent composition comprising a surfactant system and one or more diol synthases capable of converting one or more unsaturated fatty acids into one or more oxylipins. The composition provides one or more benefits, including good cleaning particularly good grease emulsification, and long lasting suds especially in presence of greasy soils

### BACKGROUND OF THE INVENTION

Detergent compositions should have a good suds profile in particular a long lasting suds profile especially in the presence of greasy soils. Users usually see suds as an indicator of the performance of the detergent composition. Moreover, the user of a detergent composition may also use the suds profile and the appearance of the suds (e.g., density, whiteness) as an indicator that the wash solution still contains active detergent ingredients. This is particularly the case for manual washing, also referred to herein as hand-washing, where the user usually doses the detergent composition depending on the suds remaining and renews the wash solution when the suds subsides or when the suds does not look thick enough. Thus, a detergent composition, particularly a manual wash detergent composition that generates little or low density suds would tend to be replaced by the user more frequently than is necessary. Accordingly, it is desirable for a detergent composition to provide “good sudsing profile”, which includes good suds height and density as well as good suds duration during the initial mixing of the detergent with water and/or during the entire washing operation.

Unsaturated fatty acids can be oxidized in the presence of molecular oxygen (O₂) by dioxygenases, such as diol synthases, to produce oxylipins. Diol synthases include linoleate diol synthases and oleate diol synthases. The linoleate diol synthase belongs to the family of oxidoreductases. Diol synthases, particularly linoleate diol synthases, have been generally disclosed as a component in combination with a resin for water-soluble film flakes, particularly the use of the film flakes to manufacture water-soluble packaging for single use fabric or dish detergent packets (Water Soluble Film Flakes Incorporating Functional Ingredients, IP.COM Journal, 2 Jan. 2014). However, the inclusion of diol synthases, particularly linoleate diol synthases and/or oleate diol synthases in the context of liquid hand dishwashing detergent compositions for improving sudsing profile, particularly increased suds longevity especially in the presence of greasy soils, has not been disclosed.

Accordingly, the need remains for an improved liquid detergent composition comprising diol synthases and a specific surfactant system, which provides a good sudsing profile, in particular enhanced suds boosting and/or increased suds longevity, especially in the presence of greasy soils. The need also exists for an improved detergent composition, when used in a manual-washing process, the composition preferably also provides a pleasant washing experience, i.e, good feel on the user's hands during the wash. Preferably the detergent compositions are also easy to rinse. Further it is desirous that the improved detergent composition is stable and will not phase separate, resulting in greater shelf-life of the product. Preferably in addition, the composition provides a good finish to the washed items. There is also the desire to reduce the amount of surfactants without negatively impacting sudsing nor grease cleaning and emulsification profile. Thus, there is the need to find new compositions that improve cleaning and suds longevity in hand washing conditions.

It has been found that some types of soil, in particular greasy soils comprising unsaturated fatty acids, act as a suds suppressor, triggering consumers to replace the product more frequently than is necessary. As such there is a need to provide detergent compositions with desirable suds properties, especially in the presence of greasy soils, even more in the presence of greasy soils comprising unsaturated fatty acids, and that at the same time provide good soil and grease removal. Surprisingly, the Applicant discovered that some or all of the above-mentioned needs can be at least partially fulfilled through the improved detergent composition comprising one or more diol synthases and a specific surfactant system.

### SUMMARY OF THE INVENTION

The present invention meets one or more of these needs based on the surprising discovery that by formulating a detergent composition comprising one or more diol synthases capable of converting one or more unsaturated fatty acids into one or more oxylipins, and a surfactant system, such a composition exhibits good sudsing profile, particularly desirable suds volume and/or sustained suds stabilization, especially in the presence of greasy soils. It also provides good grease cleaning and emulsification benefits.

According to the present invention there is provided a detergent composition comprising: a) one or more diol synthases capable of converting one or more unsaturated fatty acids into one or more oxylipins and b) a surfactant system. Preferably the diol synthases are selected from the group consisting of linoleate diol synthases, oleate diol synthases, and mixtures thereof. More preferably the diol synthases are selected from the group consisting of: linoleate diol synthases (EC 1.13.11.44), 5,8-linoleate diol synthases (EC 1.13.11.60 and EC 5.4.4.5), 7,8-linoleate diol synthases (EC 1.13.11.60 and EC 5.4.4.6), 9,14-linoleate diol synthases (EC 1.13.11.B1), 8,11-linoleate diol synthases, oleate diol synthases, and mixtures thereof, even more preferably 5,8-linoleate diol synthases (EC 1.13.11.60 and EC 5.4.4.5), and mixtures thereof. The surfactant system comprises one or more anionic surfactants and one or more co-surfactants selected from the group consisting of amphoteric surfactant, zwitterionic surfactant, and mixtures thereof, wherein the weight ratio of said anionic surfactants to said co-surfactants is less than 9:1, more preferably from 5:1 to 1:1, more preferably from 4:1 to 2:1.

The detergent composition is a liquid manual dishwashing composition. Preferably the composition of the invention provides good cleaning and good suds profile, especially in the presence of greasy soils.

According to the present invention, there is provided a method of manually washing dishware comprising the steps of delivering a detergent composition of the invention into a volume of water to form a wash solution and immersing the dishware in said solution.

According to the present invention, there is provided a method of manually washing dishware comprising the steps of: a) delivering the detergent composition of the invention to a volume of water to form a wash liquor; and b) immersing the soiled articles into said wash liquor. When the composition of the invention is used according to this method a good sudsing profile, with a long lasting effect is achieved.

In yet another aspect, the present invention relates to a method of manually washing dishware comprising: i) delivering a composition as described herein above onto the dishware or a cleaning implement; ii) cleaning the dishware with the composition in the presence of water; and iii) optionally, rinsing the dishware. Preferably, the composition of the present invention is used in neat form (i.e., direct application) since greater benefits in terms of grease cleaning are obtained when the composition is directly applied on the soiled surface or on a cleaning implement, such as a sponge, to be used to clean the soiled surface.

There is also provided the use of one or more diol synthases capable of converting unsaturated fatty acids into one or more oxylipins to provide improved suds longevity in an aqueous wash liquor comprising soil especially greasy soil, especially greasy soil comprising unsaturated fatty acids.

The composition of the invention provides good cleaning and good suds profile, especially in the presence of greasy soils. The compositions of the present invention have been found to be particularly useful in the presence of unsaturated fatty acids or salts thereof. These may be present either in the soil or released to the wash liquor during removal of soils which break down to generate unsaturated fatty acids, such as body soils and cooking oils such as olive oil.

The manual washing is dishwashing and the soiled articles comprise soiled dishware. As used herein, “dishware” includes cookware and tableware.

The elements of the composition of the invention described in relation to the first aspect of the invention apply mutatis mutandis to the other aspects of the invention.

These and other features, aspects and advantages of the present invention will become evident to those skilled in the art from the detailed description which follows.

### DETAILED DESCRIPTION OF THE INVENTION

### Definitions

As used herein, the articles “a” and “an” when used in a claim, are understood to mean one or more of what is claimed or described.

As used herein, the term “substantially free of” or “substantially free from” means that the indicated material is present in an amount of no more than about 5 wt %, preferably no more than about 2%, and more preferably no more than about 1 wt % by weight of the composition.

As used therein, the term “essentially free of” or “essentially free from” means that the indicated material is present in an amount of no more than about 0.1 wt % by weight of the composition, or preferably not present at an analytically detectible level in such composition. It may include compositions in which the indicated material is present only as an impurity of one or more of the materials deliberately added to such compositions.

As used herein the term “diol synthase” refers to an enzyme that is capable of converting at least one unsaturated fatty acid into a mixture of oxylipins, comprising at least a dihydroxy fatty acid.

As used herein the phrase “detergent composition” refers to compositions and formulations designed for cleaning soiled surfaces. Such compositions include dish-washing compositions.

As used herein the term “improved suds longevity” means an increase in the duration of visible suds in a washing process cleaning soiled articles using the composition comprising one or more diol synthase enzymes capable of converting one or more unsaturated fatty acids into one or more oxylipins, compared with the suds longevity provided by the same composition and process in the absence of the one or more diol synthase enzymes capable of converting one or more unsaturated fatty acids into one or more oxylipins.

As used herein, the term “soiled surfaces” refers to soiled dishware.

As used herein, the term “variant” of diol synthase means an amino acid sequence when the diol synthase is modified by, or at, one or more amino acids (for example 1, 2, 3, 4, 5, 6, 7, 8, 9 or 10 or more amino acid modifications) selected from substitutions, insertions, deletions and combinations thereof. The variant may have “conservative” substitutions, wherein a substituted amino acid has similar structural or chemical properties to the amino acid that replaces it, for example, replacement of leucine with isoleucine. A variant may have “non-conservative” changes, for example, replacement of a glycine with a tryptophan. Variants may also include sequences with amino acid deletions or insertions, or both. Guidance in determining which amino acid residues may be substituted, inserted, or deleted without abolishing the activity of the protein may be found using computer programs well known in the art. Variants may also include truncated forms derived from a wild-type surface active protein, such as for example, a protein with a truncated N-terminus. Variants may also include forms derived by adding an extra amino acid sequence to a wild-type protein, such as for example, an N-terminal tag, a C-terminal tag or an insertion in the middle of the protein sequence.

As used herein, the term “water hardness” or “hardness” means uncomplexed cation ions (i.e., Ca²⁺ or Mg²⁺) present in water that have the potential to precipitate with anionic surfactants or any other anionically charged detergent actives under alkaline conditions, and thereby diminishing the surfactancy and cleaning capacity of surfactants. Further, the terms “high water hardness” and “elevated water hardness” can be used interchangeably and are relative terms for the purposes of the present invention, and are intended to include, but not limited to, a hardness level containing at least 12 grams of calcium ion per gallon water (gpg, “American grain hardness” units).

### Detergent Composition

The Applicant has surprisingly discovered a new way of formulating a detergent composition that is a liquid manual dishwashing detergent composition to provide good sudsing profile, particularly increased suds longevity, preferably in the presence of greasy soil. Essentially, the solution is to formulate a specific surfactant system which synergizes with diol synthases enzyme. In fact, the Applicant has discovered that when the specific surfactant system is co-formulated with the diol synthases, improved suds longevity, especially in the presence of greasy soil is obtained. While not wishing to be bound by theory, it is believed that the specific surfactant system containing the diol synthases may more easily go to the air-water interface and remain in the suds film lamellae due to its specific physical properties. As a result, the longevity of the suds is increased due to the surfactant-diol synthases interactions that form strong continuous interfacial membrane that stabilizes the suds particles at the air-water interface.

In addition, the Applicant has discovered that the diol synthases and specific surfactant system in the detergent composition of the present invention also provides enhanced suds boosting benefit. Preferably, the detergent composition of the invention also provides good grease removal, in particular good uncooked grease removal.

The detergent composition is a liquid manual dishwashing detergent composition. It typically contains from 30% to 95%, preferably from 40% to 90%, more preferably from 50% to 85% by weight of the composition of a liquid carrier in which the other essential and optional components are dissolved, dispersed or suspended. One preferred component of the liquid carrier is water.

Preferably the pH of the detergent composition of the invention, measured as a 10% product concentration in demineralized water at 20° C., is adjusted to between 3 and 14, more preferably between 4 and 13, more preferably between 6 and 12 and most preferably between 8 and 10. The pH of the detergent composition can be adjusted using pH modifying ingredients known in the art.

### Diol Synthases

Unexpectedly, the Applicants found that diol synthases are capable of producing a more stable hence longer lasting sudsing profile in detergent wash solutions comprising oily and/or greasy soils. Not wishing to be bound by theory, the Applicants believe that the increased sudsing benefits are due to the conversion of unsaturated fatty acids into oxygenated fatty acids with enhanced surfactant properties and decreased tendency to precipitation in the presence of hard water.

Diol synthases are fusion proteins and at least two different classes have been reported in the art. The class I fungal diol synthases, also referred as Psi-factor producing oxygenases (Ppo), contain an N-terminal dioxygenase (DOX) domain and a C-terminal cytochrome P450/hydroperoxide isomerase (HPI) domain; while the class II bacterial diol synthases consists of an N-terminal allene oxide synthase (AOS) domain and a C-terminal dioxygenase (DOX) domain. In the first step of the reaction, the unsaturated fatty acid (e.g., linoleic acid) is converted to a hydroperoxy fatty acid derivative by the DOX domain, frequently followed by isomerization to a dihydroxy fatty acid by the HPI domain or the AOS domain.

Several amino acid residues are conserved in class I diol synthases. For example, in the DOX domain, the YR(W/F)H motif containing the catalytic Tyr is highly conserved. In the HPI domain, the SRS-4 region motif ANQXQ, the EXXG motif, and the heme signature motif (G/E)(P/A)HX(C/S)(L/F/G) are also frequently found in diol synthases. The His and Cys residues of the heme motif and the last Asn of the SRS-4 region have been associated with the isomerization step and the type of oxylipins generated during the reaction.

The present invention comprises different groups of diol synthases, including linoleate diol synthases and oleate diol synthases. Even though oleate diol synthases typically recognize oleic acid/oleate as the preferred substrate and linoleate diol synthases recognize linoleic acid/linoleate as the preferred substrate, the terms “oleate diol synthase” and “linoleate diol synthase” are used interchangeably herein and do not suggest any substrate specificity, i.e., the respective enzymes can act on both substrates.

Based on the reaction products, several diol synthases have been characterized: 5,8-linoleate diol synthases (5,8-LDS), 7,8-linoleate diol synthases (7,8-LDS), 8,11-linoleate diol synthases (8,11-LDS), and 9,14-linoleate diol synthases (9,14-LDS). Although they are frequently referred as linoleate diol synthases, they can convert substrates different than linoleate (e.g., oleate).

Non-limiting examples of 5,8-LDS include Emericella nidulans PpoA (SEQ ID NO: 1), Aspergillus fumigatus PpoA (SEQ ID NO: 2), Aspergillus terreus PpoA (SEQ ID NO: 3), Aspergillus kawachii PpoA (SEQ ID NO: 4), Aspergillus clavatus PpoA (SEQ ID NO: 5), Aspergillus niger PpoA (SEQ ID NO: 6). For instance, A. nidulans PpoA (SEQ ID NO: 1) converts C16 and C18 unsaturated fatty acids, including palmitoleic acid, oleic acid, linoleic acid, and α-linolenic acid, into 5,8-dihydroxy fatty acids, and converts C20 unsaturated fatty acids, including eicosenoic acid, eicosadienoic acid and eicosatrienoic acid, to 7,10-dihydroxy fatty acids (Brodhun, F., et al. (2009), J. Biol. Chem. 284(18): 11792-11805 and Jerneren, F., et al. (2010), Biochim. Biophys. Acta, Mol. Cell Biol. Lipids 1801(4): 503-507).

Non-limiting examples of 7,8-LDS include Glomerella cingulate 7,8-LDS (SEQ ID NO: 7), Gaeumannomyces graminis 7,8-LDS (SEQ ID NO: 8), and Magnaporthe oryzae 7,8-LDS (SEQ ID NO: 9). For instance, G. graminis 7,8-LDS converts oleic acid, linoleic acid, and α-linolenic acid into 7,8-dihydroxy fatty acids as major products, but this enzyme does not show activity when γ-linolenic acid, eicosatrienoic acid, arachidonis acid, and eicosapentaenoic acid are used as substrates. Similarly, G. cingulate 7,8-LDS converts palmitoleic acid, oleic acid, linoleic acid, and α-linolenic acid to 7,8-dihydroxy fatty acids, but also processes eicosenoic acid, eicosadienoic acid, dihomo-γ-linolenic acid, and arachidonic acid to 8-hydroperoxy fatty acids by using only the N-terminal dioxygenase domain (Seo, M.-J., et al. (2016), Appl. Microbiol. Biotechnol. 100(7): 3087-3099).

Non-limiting examples of 8,11-LDS include Penicillium oxalicum 8,11-LDS (SEQ ID NO: 10), Penicillium chrysogenum 8,11-LDS (SEQ ID NO: 11) and Penicillium digitatum 8,11-LDS (SEQ ID NO: 12). For instance, Penicillium chrysogenum 8,11-LDS converts linoleic acid and α-linolenic acid to 8,11-dihydroxy fatty acids, whereas oleic acid and palmitoleic acid are converted to 8-hydroxy fatty acids. Interestingly, the Q898E or Q898L variants of G. cingulate 7,8-LDS also converts linoleic acid to the 8,11-dihydroxy fatty acid (Shin, K.-C., et al. (2016), J. Lipid Res. 57(2): 207-218).

Non-limiting examples of 9,14-LDS include Nostoc sp. PCC 7120 9,14-LDS (SEQ ID NO: 13) and Acaryochloris marina putative 9,14-LDS (SEQ ID NO: 14) and Nostoc sp. NIES-4103 putative 9,14-LDS (SEQ ID NO: 15). Nostoc sp. PCC 7120 9,14-LDS converts linoleic acid into the 9,14-dihydroxy fatty acid as the main product with 9,10-dihydroxy, 8-11-dihydroxy, and 9-hydroxy fatty acids; α-linolenic acid to 9,16-dihydroxy, 9,13-dihidroxy, and 9-hydroxy fatty acids; and 7-linolenic acid to 9,14-dihidroxy and 9-hydroxy fatty acids (Lang, I., et al. (2008), Biochem. J. 410(2): 347-357).

Other dihydroxylation patterns have been observed in nature, but the enzymes have not been characterized yet. For example, Bacillus megaterium ALA2 and Clavibacter sp. ALA2 produce 12,13-dihydroxy fatty acids from linoleic acid. In another example, the red alga Gracilariopsis lemaneiformis produces 9,10-dihydroxy, 12,12-dihydroxy, and 12-hydroxy fatty acids from arachidonic acid. Finally, Leptomitus lacteus converts linoleic acid to 8,11-dihydroxy, 11,16-dihydroxy, 11,17-dihydroxy, 7-hydroxy, and 8-hydroxy fatty acids. Thus, diol synthases, can be used to convert unsaturated fatty acids into different hydroxylated products (Kim, K.-R. and D.-K. Oh (2013), Biotechnol. Adv. 31(8): 1473-1485).

The diol synthases are capable of transforming one or more unsaturated fatty acids into one or more oxylipins and are preferably present in the composition in an amount of from 0.0001 wt % to 1 wt % by weight of the cleaning composition based on active protein. More preferably the diol synthases may be present in the amounts from 0.001 wt % to 0.2 wt % by weight of the cleaning composition based on active protein.

Preferably the diol synthases are selected from the group consisting of: linoleate diol synthases (EC 1.13.11.44), 5,8-linoleate diol synthases (EC 1.13.11.60 and EC 5.4.4.5), 7,8-linoleate diol synthases (EC 1.13.11.60 and EC 5.4.4.6), 9,14-linoleate diol synthases (EC 1.13.11.B1), 8,11-linoleate diol synthases, oleate diol synthases, and mixtures thereof.

Preferably the diol synthases have at least 60%, preferably at least 70%, preferably at least 80%, preferably at least 85%, preferably at least 90%, preferably at least 95%, preferably at least 98% or preferably even 100% identity as calculated over the entire length of the sequence aligned against the entire length of at least one reference sequence of the wild-type diol synthases selected from the group consisting of Emericella nidulans PpoA (SEQ ID NO: 1), Aspergillus fumigatus PpoA (SEQ ID NO: 2), Aspergillus terreus PpoA (SEQ ID NO: 3), Aspergillus kawachii PpoA (SEQ ID NO: 4), Aspergillus clavatus PpoA (SEQ ID NO: 5), Aspergillus niger PpoA (SEQ ID NO: 6), Glomerella cingulate 7,8-LDS (SEQ ID NO: 7), Gaeumannomyces graminis 7,8-LDS (SEQ ID NO: 8), Magnaporthe oryzae 7,8-LDS (SEQ ID NO: 9), Penicillium oxalicum 8,11-LDS (SEQ ID NO: 10), Penicillium chrysogenum 8,11-LDS (SEQ ID NO: 11) and Penicillium digitatum 8,11-LDS (SEQ ID NO: 12), Nostoc sp. PCC 7120 9,14-LDS (SEQ ID NO: 13), Acaryochloris marina putative 9,14-LDS (SEQ ID NO: 14) and Nostoc sp. NIES-4103 putative 9,14-LDS (SEQ ID NO: 15).

Preferably the diol synthases are 5,8-linoleate diol synthases (EC 1.13.11.60 and EC 5.4.4.5). Preferably the 5,8-linoleate diol synthases (EC 1.13.11.60 and EC 5.4.4.5) have at least 60%, preferably at least 70%, preferably at least 80%, preferably at least 85%, preferably at least 90%, preferably at least 95%, preferably at least 98% or preferably even 100% identity as calculated over the entire length of the sequence aligned against the entire length of at least one reference sequence of the wild-type diol synthases selected from the group consisting of Emericella nidulans PpoA (SEQ ID NO: 1), Aspergillus fumigatus PpoA (SEQ ID NO: 2), Aspergillus terreus PpoA (SEQ ID NO: 3), Aspergillus kawachii PpoA (SEQ ID NO: 4), Aspergillus clavatus PpoA (SEQ ID NO: 5), Aspergillus niger PpoA (SEQ ID NO: 6), and mixtures thereof, more preferably Emericella nidulans PpoA (SEQ ID NO: 1).

The present invention also includes variants of diol synthases. Variants of diol synthases, as used herein, include a sequence resulting when a wild-type protein of the respective protein is modified by, or at, one or more amino acids (for example 1, 2, 5 or 10 amino acids). The invention also includes variants in the form of truncated forms derived from a wild-type diol synthase, such as a protein with a truncated N-terminus or a truncated C-terminus. Some diol synthases may include an N-terminal signal peptide that is likely removed upon secretion by the cell. The present invention includes variants without the N-terminal signal peptide. Bioinformatic tools, such as SignalP ver 4.1 (Petersen T N., Brunak S., von Heijne G. and Nielsen H. (2011), Nature Methods, 8:785-786), can be used to predict the existence and length of such signal peptides. The invention also includes variants derived by adding an extra amino acid sequence to a wild-type protein, such as for example, an N-terminal tag, a C-terminal tag or an insertion in the middle of the protein sequence. Non-limiting examples of tags are maltose binding protein (MBP) tag, glutathione S-transferase (GST) tag, thioredoxin (Trx) tag, His-tag, and any other tags known by those skilled in art. Tags can be used to improve solubility and expression levels during fermentation or as a handle for enzyme purification.

It is important that variants of diol synthases retain and preferably improve the ability of the wild-type protein to catalyze the conversion of the unsaturated fatty acids. Some performance drop in a given property of variants may of course be tolerated, but the variants should retain and preferably improve suitable properties for the relevant application for which they are intended. Screening of variants of one of the wild-types can be used to identify whether they retain and preferably improve appropriate properties.

The variants may have “conservative” substitutions. Suitable examples of conservative substitution includes one conservative substitution in the enzyme, such as a conservative substitution in SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, or SEQ ID NO: 15. Other suitable examples include 10 or fewer conservative substitutions in the protein, such as five or fewer. An enzyme of the invention may therefore include 1, 2, 3, 4, 5, 6, 7, 8, 9, 10 or more conservative substitutions. An enzyme can be produced to contain one or more conservative substitutions by manipulating the nucleotide sequence that encodes that enzyme using, for example, standard procedures such as site-directed mutagenesis or PCR.

Examples of amino acids which may be substituted for an original amino acid in an enzyme and which are regarded as conservative substitutions include: Ser for Ala; Lys for Arg; Gln or His for Asn; Glu for Asp; Asn for Gln; Asp for Glu; Pro for Gly; Asn or Gln for His; Leu or Val for Ile; Ile or Val for Leu; Arg or Gln for Lys; Leu or Ile for Met; Met, Leu or Tyr for Phe; Thr for Ser; Ser for Thr; Tyr for Trp; Trp or Phe for Tyr; and Ile or Leu for Val.

A variant includes a “modified enzyme” or a “mutant enzyme” which encompasses proteins having at least one substitution, insertion, and/or deletion of an amino acid. A modified enzyme may have 1, 2, 3, 4, 5, 6, 7, 8, 9 or 10 or more amino acid modifications (selected from substitutions, insertions, deletions and combinations thereof).

Enzymes can be modified by a variety of chemical techniques to produce derivatives having essentially the same or preferably improved activity as the unmodified enzymes, and optionally having other desirable properties. For example, carboxylic acid groups of the protein, whether carboxyl-terminal or side chain, may be provided in the form of a salt of a pharmaceutically-acceptable cation or esterified, for example to form a C1-C6 alkyl ester, or converted to an amide, for example of formula CONR1R2 wherein R1 and R2 are each independently H or C1-C6 alkyl, or combined to form a heterocyclic ring, such as a 5- or 6-membered ring. Amino groups of the enzyme, whether amino-terminal or side chain, may be in the form of a pharmaceutically-acceptable acid addition salt, such as the HCl, HBr, acetic, benzoic, toluene sulfonic, maleic, tartaric and other organic salts, or may be modified to C1-C20 alkyl or dialkyl amino or further converted to an amide. Hydroxyl groups of the protein side chains may be converted to alkoxy or ester groups, for example C1-C20 alkoxy or C1-C20 alkyl ester, using well-recognized techniques. Phenyl and phenolic rings of the protein side chains may be substituted with one or more halogen atoms, such as F, Cl, Br or I, or with C1-C20 alkyl, C1-C20 alkoxy, carboxylic acids and esters thereof, or amides of such carboxylic acids. Methylene groups of the protein side chains can be extended to homologous C2-C4 alkylenes. Thiols can be protected with any one of a number of well-recognized protecting groups, such as acetamide groups. Those skilled in the art will also recognize methods for introducing cyclic structures into the proteins of this disclosure to select and provide conformational constraints to the structure that result in enhanced stability.

Identity, or homology, percentages as mentioned herein in respect of the present invention are those that can be calculated with the GAP program, obtainable from GCG (Genetics Computer Group Inc., Madison, Wis., USA). Alternatively, a manual alignment can be performed.

For enzyme sequence comparison the following settings can be used: Alignment algorithm: Needleman and Wunsch, J. Mol. Biol. 1970, 48: 443-453. As a comparison matrix for amino acid similarity the Blosum62 matrix is used (Henikoff S. and Henikoff J. G., P.N.A.S. USA 1992, 89: 10915-10919). The following gap scoring parameters are used: Gap penalty: 12, gap length penalty: 2, no penalty for end gaps.

A given sequence is typically compared against the full-length sequence of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, or SEQ ID NO: 15 to obtain a score.

The diol synthases may be incorporated into the detergent composition via an additive particle, such as an enzyme granule or in the form of an encapsulate, or may be added in the form of a liquid formulation.

In particular when the detergent composition comprises a liquid, it may be preferred to incorporate the enzyme via an encapsulate. Encapsulating the enzyme promotes the stability of the enzyme in the composition and helps to counteract the effect of any hostile compounds present in the composition, such as bleach, protease, surfactant, chelant, etc.

The diol synthases when present in an additive particle may be the only enzyme in the additive particle or may be present in the additive particle in combination with one or more additional enzymes.

Preferably the composition of the invention may further comprise one or more co-enzymes selected from the group consisting of: fatty-acid peroxidases (EC 1.11.1.3), unspecific peroxygenases (EC 1.11.2.1), plant seed peroxygenases (EC 1.11.2.3), fatty acid peroxygenases (EC1.11.2.4), linoleate 13S-lipoxygenases (EC 1.13.11.12), arachidonate 12-lipoxygenases (E.C. 1.13.11.31), arachidonate 15-lipoxygenase (EC 1.13.11.33), arachidonate 5-lipoxygenases (EC 1.13.11.34), arachidonate 8-lipoxygenases (EC 1.13.11.40), linoleate 11-lipoxygenases (EC 1.13.11.45), linoleate 9S-lipoxygenases (EC 1.13.11.58), linoleate 8R-lipoxygenases (EC 1.13.11.60), linoleate 9R-lipoxygenases (EC 1.13.11.61), linoleate 10R-lipoxygenases (EC 1.13.11.62), oleate 10S-lipoxygenases (EC 1.13.11.77), linoleate 9/13-lipoxygenases (EC 1.13.11.B6), linoleate 10S-lipoxygenases, unspecific monooxygenase (EC 1.14.14.1), alkane 1-monooxygenase (EC 1.14.15.3), oleate 12-hydroxylases (EC 1.14.18.4), cyclooxygenases (EC 1.14.99.1), fatty acid amide hydrolase (EC 3.5.1.99), oleate hydratases (EC 4.2.1.53), allene oxide synthases (EC 4.2.1.92), hydroperoxide isomerases (EC 4.2.1.92, EC 5.3.99.1, EC 5.4.4.5, EC 5.4.4.6), hydroperoxide lyases (EC 4.2.1.92), hydroperoxide dehydratases (EC 4.2.1.92), divinyl ether synthases (EC 4.2.1.121, EC 4.2.1.B8, EC 4.2.1.B9), linoleate isomerases (EC 5.2.1.5), linoleate (10E,12Z)-isomerases (EC 5.3.3.B2), 9,12-octadecadienoate 8-hydroperoxide 8R-isomerases (EC 5.4.4.5), 9,12-octadecadienoate 8-hydroperoxide 8S-isomerases (EC 5.4.4.6), 7,10-hydroperoxide diol synthases, fatty acid decarboxylases (OleT-like), iron-dependent decarboxylases (UndA-like), epoxy alcohol synthases, other CYP450 monooxygenases, amylases, lipases, proteases, cellulases, and mixtures thereof.

Preferably the co-enzymes are linoleate 9S-lipoxygenases (EC 1.13.11.58), linoleate 8R-lipoxygenases (EC 1.13.11.60), linoleate 9R-lipoxygenases (EC 1.13.11.61), linoleate 10R-lipoxygenases (EC 1.13.11.62), oleate 10S-lipoxygenases (EC 1.13.11.77), linoleate 9/13-lipoxygenases (EC 1.13.11.B6), linoleate 10S-lipoxygenases, oleate hydratases (EC 4.2.1.53), hydroperoxide isomerases (EC 4.2.1.92, EC 5.3.99.1, EC 5.4.4.5, EC 5.4.4.6), hydroperoxide lyases (EC 4.2.1.92), hydroperoxide dehydratases (EC 4.2.1.92), 9,12-octadecadienoate 8-hydroperoxide 8R-isomerases (EC 5.4.4.5), 9,12-octadecadienoate 8-hydroperoxide 8S-isomerases (EC 5.4.4.6), 7,10-hydroperoxide diol synthases, fatty acid decarboxylases (OleT-like), iron-dependent decarboxylases (UndA-like), and mixture therefore, more preferably oleate 10S-lipoxygenases (EC 1.13.11.77), 9,12-octadecadienoate 8-hydroperoxide 8R-isomerases (EC 5.4.4.5), 9,12-octadecadienoate 8-hydroperoxide 8S-isomerases (EC 5.4.4.6), 7,10-hydroperoxide diol synthases, and mixtures thereof.

Other suitable additional co-enzymes include protease such as metalloprotease or alkaline serine protease, such as subtilisin, mannanase, pectinase, DNAse, oxidoreductase, peroxidases, lipases, phospholipases, cellobiohydrolases, cellobiose dehydrogenases, esterases, cutinases, pectinases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

Preferably the unsaturated fatty acids are selected from the group consisting of: mono unsaturated fatty acids, di unsaturated fatty acids, tri unsaturated fatty acids, tetra unsaturated fatty acids, penta unsaturated fatty acids, hexa unsaturated fatty acids, and mixtures thereof; preferably myristoleic acid, palmitoleic acid, sapienic acid, oleic acid, elaidic acid, vaccenic acid, linoleic acid, linoelaidic acid, α-linolenic acid, 7-linolenic acid, gadoleic acid, α-eleostearic acid, β-eleostearic acid, ricinoleic acid, eicosenic acid, arachidonic acid, eicosapentaenoic acid, erucic acid, docosadienoic acid, docosahexaenoic acid, tetracosenoic acid, and mixtures thereof, preferably palmitoleic acid, oleic acid, linoleic acid, α-linolenic acid, 7-linolenic acid, and mixtures thereof, more preferably oleic acid.

Preferably the oxylipins are selected from the group consisting of: hydroperoxy fatty acids, monohydroxy fatty acids, dihydroxy fatty acids, trihydroxyfatty acids, polyhydroxy fatty acids, their derivatives, and mixtures thereof; preferably said oxylipins are selected from the group consisting of: unsaturated monohydroxy fatty acids, unsaturated dihydroxy fatty acids, unsaturated 8R-hydroperoxy fatty acids, unsaturated 9R-hydroperoxy fatty acids, their derivatives, and mixtures thereof; more preferably unsaturated dihydroxy fatty acids; even more preferably 5,8-dihydroxy oleic acid.

Where necessary, the composition comprises, provides access to or forms in situ any additional substrate necessary for the effective functioning of the enzyme. For example, molecular oxygen is provided as an additional substrate for diol synthases; water for oleate hydratases; and hydrogen peroxide for peroxidases, peroxygenase, lipoxygenases, and/or fatty acid decarboxylases (OleT-like).

### Surfactant System

Preferably the detergent composition of the invention comprises from 1% to 60%, preferably from 5% to 50%, more preferably from 8% to 40%, by weight of the total composition of a surfactant system.

The surfactant system of the composition of the present invention comprises an anionic surfactant. Preferably, the surfactant system for the cleaning composition of the present invention comprises from 1% to 40%, preferably 6% to 35%, more preferably 8% to 30% by weight of the total composition of an anionic surfactant. The anionic surfactant can be any anionic cleaning surfactant, preferably selected from sulfate and/or sulfonate anionic surfactants. HLAS (linear alkylbenzene sulfonate) would be the most preferred sulfonate anionic surfactant. Especially preferred anionic surfactant is selected from the group consisting of alkyl sulfate, alkyl alkoxy sufate and mixtures thereof, and preferably wherein the alkyl alkoxy sulfate is an alkyl ethoxy sulfate. Preferred anionic surfactant is a combination of alkyl sulfates and alkyl ethoxy sulfates with a combined average ethoxylation degree of less than 5, preferably less than 3, more preferably less than 2 and more than 0.5 and an average level of branching of from 5% to 40%, more preferably from 10% to 35%, and even more preferably from 20% to 30%.

The average alkoxylation degree is the mol average alkoxylation degree of all the components of the mixture (i.e., mol average alkoxylation degree) of the anionic surfactant. In the mol average alkoxylation degree calculation the weight of sulfate anionic surfactant components not having alkoxylate groups should also be included.

Mol average alkoxylation degree=(x1*alkoxylation degree of surfactant 1+x2*alkoxylation degree of surfactant 2+ . . . )/(x1+x2+ . . . )

wherein x1, x2, . . . are the number of moles of each sulfate anionic surfactant of the mixture and alkoxylation degree is the number of alkoxy groups in each sulfate anionic surfactant.

The average level of branching is the weight average % of branching and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the composition of the invention. In the weight average branching degree calculation the weight of anionic surfactant components not having branched groups should also be included.

Suitable examples of commercially available sulfates include, those based on Neodol alcohols ex the Shell company, Lial-Isalchem and Safol ex the Sasol company, natural alcohols ex The Procter & Gamble Chemicals company. Suitable sulfonate surfactants for use herein include water-soluble salts of C8-C18 alkyl or hydroxyalkyl sulfonates; C11-C18 alkyl benzene sulfonates (LAS), modified alkylbenzene sulfonate (MLAS); methyl ester sulfonate (MES); and alpha-olefin sulfonate (AOS). Those also include the paraffin sulfonates may be monosulfonates and/or disulfonates, obtained by sulfonating paraffins of 10 to 20 carbon atoms. The sulfonate surfactant also include the alkyl glyceryl sulfonate surfactants.

The surfactant system of the composition of the present invention further comprises a primary co-surfactant system, wherein the primary co-surfactant system is selected from the group consisting of amphoteric surfactant, zwitterionic surfactant, and mixtures thereof. Preferably, the surfactant system for the composition of the present invention comprises from 0.5% to 15%, preferably from 1% to 12%, more preferably from 2% to 10%, by weight of the total composition of a primary co-surfactant system.

Preferably, the primary co-surfactant system is an amphoteric surfactant. Preferably, the primary co-surfactant system is an amine oxide surfactant, and wherein the composition comprises anionic surfactant and amine oxide surfactant in a weight ratio of less than 9:1, more preferably from 5:1 to 1:1, more preferably from 4:1 to 2:1, preferably from 3:1 to 2.5:1. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or branched alkyl moiety.

Optionally the amine oxide surfactant is a mixture of amine oxides comprising a low-cut amine oxide and a mid-cut amine oxide. The amine oxide of the composition of the invention then comprises:
a) from 10% to 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls or mixtures thereof, and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl. In another preferred low-cut amine oxide for use herein R1 and R2 are both methyl. In an especially preferred low-cut amine oxide for use herein R1 and R2 are both methyl and R3 is n-decyl.

Preferably, the amine oxide comprises less than 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Compositions comprising R7R8R9AO tend to be unstable and do not provide very suds mileage.

Preferably the primary co-surfactant system is a zwitterionic surfactant. Suitable exampes of zwitterionic surfactants include betaines, such as alkyl betaines, alkylamidobetaine, amidazoliniumbetaine, sulfobetaine (INCI Sultaines) as well as the Phosphobetaine and preferably meets formula (I):

R1-[CO—X(CH2)n]x-N+(R2)(R3)-(CH2)m-[CH(OH)—CH2]y-Y— (I)

wherein
R1 is a saturated or unsaturated C6-22 alkyl residue, preferably C8-18 alkyl residue, in particular a saturated C10-16 alkyl residue, for example a saturated C12-14 alkyl residue;
X is NH, NR4 with C1-4 Alkyl residue R4, 0 or S;
n is a number from 1 to 10, preferably 2 to 5, in particular 3;
x is 0 or 1, preferably 1;
R2 and R3 are independently a C1-4 alkyl residue, potentially hydroxy substituted such as a hydroxyethyl, preferably a methyl;
m is a number from 1 to 4, in particular 1, 2 or 3;
y is 0 or 1; and
Y is COO, SO3, OPO(OR5)O or P(O)(OR5)O, whereby R5 is a hydrogen atom H or a C1-4 alkyl residue.

Preferred betaines are the alkyl betaines of the formula (Ia), the alkyl amido propyl betaine of the formula (Ib), the Sulfo betaines of the formula (Ic), and the Amido sulfobetaine of the formula (Id);

R1-N+(CH3)2-CH2COO— (Ia)

R1-CO—NH(CH2)3-N+(CH3)2-CH2COO— (Ib)

R1-N+(CH3)2-CH2CH(OH)CH2SO3- (Ic)

R1-CO—NH—(CH2)3-N+(CH3)2-CH2CH(OH)CH2SO3- (Id)

in which R1 has the same meaning as in formula (I). Particularly preferred betaines are the Carbobetaine [wherein Y—═COO—], in particular the Carbobetaine of the formula (Ia) and (Ib), more preferred are the Alkylamidobetaine of the formula (Ib). A preferred betaine is, for example, Cocoamidopropylbetaine.

Preferably the surfactant system of the composition of the present invention further comprises from 0.1% to 10% by weight of the total composition of a secondary co-surfactant system preferably comprising a non-ionic surfactant. Suitable non-ionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to carbon atoms with from 2 to 18 moles, preferably 2 to 15, more preferably 5-12 of ethylene oxide per mole of alcohol. Highly preferred non-ionic surfactants are the condensation products of guerbet alcohols with from 2 to 18 moles, preferably 2 to 15, more preferably 5-12 of ethylene oxide per mole of alcohol. Preferably, the non-ionic surfactants are an alkyl ethoxylated surfactants, preferably comprising from 9 to 15 carbon atoms in its alkyl chain and from 5 to 12 units of ethylene oxide per mole of alcohol. Other suitable non-ionic surfactants for use herein include fatty alcohol polyglycol ethers, alkylpolyglucosides and fatty acid glucamides, preferably alkylpolyglucosides. Preferably the alkyl polyglucoside surfactant is a C8-C16 alkyl polyglucoside surfactant, preferably a C8-C14 alkyl polyglucoside surfactant, preferably with an average degree of polymerization of between 0.1 and 3, more preferably between 0.5 and 2.5, even more preferably between 1 and 2. Most preferably the alkyl polyglucoside surfactant has an average alkyl carbon chain length between 10 and 16, preferably between 10 and 14, most preferably between 12 and 14, with an average degree of polymerization of between 0.5 and 2.5 preferably between 1 and 2, most preferably between 1.2 and 1.6. C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Preferably, the composition comprises the anionic surfactant and the non-ionic surfactant in a ratio of from 2:1 to 50:1, preferably 2:1 to 10:1.

### Enzyme Stabilizer

Preferably the composition of the invention comprises an enzyme stabilizer. Suitable enzyme stabilizers may be selected from the group consisting of (a) univalent, bivalent and/or trivalent cations preferably selected from the group of inorganic or organic salts of alkaline earth metals, alkali metals, aluminum, iron, copper and zinc, preferably alkali metals and alkaline earth metals, preferably alkali metal and alkaline earth metal salts with halides, sulfates, sulfites, carbonates, hydrogencarbonates, nitrates, nitrites, phosphates, formates, acetates, propionates, citrates, maleates, tartrates, succinates, oxalates, lactates, and mixtures thereof. In a preferred embodiment the salt is selected from the group consisting of sodium chloride, calcium chloride, potassium chloride, sodium sulfate, potassium sulfate, sodium acetate, potassium acetate, sodium formate, potassium formate, calcium lactate, calcium nitrate and mixtures thereof. Most preferred are salts selected from the group consisting of calcium chloride, potassium chloride, potassium sulfate, sodium acetate, potassium acetate, sodium formate, potassium formate, calcium lactate, calcium nitrate, and mixtures thereof, and in particular potassium salts selected from the group of potassium chloride, potassium sulfate, potassium acetate, potassium formate, potassium propionate, potassium lactate and mixtures thereof. Most preferred are potassium acetate and potassium chloride. Preferred calcium salts are calcium formate, calcium lactate and calcium nitrate including calcium nitrate tetrahydrate. Calcium and sodium formate salts may be preferred. These cations are present at at least 0.01 wt %, preferably at least 0.03 wt %, more preferably at least 0.05 wt %, most preferably at least 0.25 wt % up to 2 wt % or even up to 1 wt % by weight of the total composition. These salts are formulated from 0.1 wt % to 5 wt %, preferably from 0.2 wt % to 4 wt %, more preferably from 0.3 wt % to 3 wt %, most preferably from 0.5 wt % to 2 wt % relative to the total weight of the composition. Further enzyme stabilizers can be selected from the group (b) carbohydrates selected from the group consisting of oligosaccharides, polysaccharides and mixtures thereof, such as a monosaccharide glycerate as described in WO201219844; (c) mass efficient reversible protease inhibitors selected from the group consisting of phenyl boronic acid and derivatives thereof, preferably 4-formyl phenylboronic acid; (d) alcohols such as 1,2-propane diol, propylene glycol; (e) peptide aldehyde stabilizers such as tripeptide aldehydes such as Cbz-Gly-Ala-Tyr-H, or disubstituted alaninamide; (f) carboxylic acids such as phenyl alkyl dicarboxylic acid as described in WO2012/19849 or multiply substituted benzyl carboxylic acid comprising a carboxyl group on at least two carbon atoms of the benzyl radical such as described in WO2012/19848, phthaloyl glutamine acid, phthaloyl asparagine acid, aminophthalic acid and/or an oligoamino-biphenyl-oligocarboxylic acid; and (g) mixtures thereof.

### Additional Enzymes

Preferred compositions of the invention comprise one or more enzymes selected from lipases, proteases, cellulases, amylases and any combination thereof.

Each additional enzyme is typically present in an amount from 0.0001 wt % to 1 wt % (weight of active protein) more preferably from 0.0005 wt % to 0.5 wt %, most preferably 0.005-0.1%. It may be particularly preferred for the compositions of the present invention to additionally comprise a lipase enzyme. Lipases break down fatty ester soils into fatty acids which are then acted upon by the unsaturated fatty acid-transforming enzyme into suds neutral or suds boosting agents.

It may be particularly preferred for the compositions of the present invention to additionally comprise a protease enzyme. Since oleic acid and other foam suppressing unsaturated fatty acids are present in body soils or even human skin, as protease enzyme acts as a skin care agent, or breaks down proteinaceous soils, fatty acids released are broken down, preventing suds suppression.

It may be particularly preferred for the compositions of the present invention to additionally comprise an amylase enzyme. Since oily soils are commonly entrapped in starchy soils, the amylase and unsaturated fatty acid transforming enzymes work synergistically together: fatty acid soils are released by breakdown of starchy soils with amylase, thus, the unsaturated fatty acid transforming enzyme is particularly effective in ensuring there is no negative impact on suds in the wash liquor.

### Salt

The composition of the present invention may optionally comprise from 0.01% to 3%, preferably from 0.05% to 2%, more preferably from 0.2% to 1.5%, or most preferably 0.5% to 1%, by weight of the total composition of a salt, preferably a monovalent, divalent inorganic salt or a mixture thereof, preferably sodium chloride. Most preferably the composition alternatively or further comprises a multivalent metal cation in the amount of from 0.01 wt % to 3 wt %, preferably from 0.05% to 2%, more preferably from 0.2% to 1.5%, or most preferably 0.5% to 1% by weight of said composition, preferably said multivalent metal cation is magnesium, aluminium, copper, calcium or iron, more preferably magnesium, most preferably said multivalent salt is magnesium chloride. Without wishing to be bound by theory, it is believed that use of a multivalent cation helps with the formation of protein/protein, surfactant/surfactant or hybrid protein/surfactant network at the oil water and air water interface that is strengthening the suds.

### Carbohydrates

Preferably the composition of the present invention comprises one or more carbohydrates selected from the group comprising O-glycan, N-glycan, and mixtures thereof. Preferably the cleaning composition further comprises one or more carbohydrates selected from the group comprising derivatives of glucose, mannose, lactose, galactose, allose, altrose, gulose, idose, talose, fucose, fructose, sorbose, tagatose, psicose, arabinose, ribose, xylose, lyxose, ribulose, and xylulose. More preferably the cleaning composition comprises one or more carbohydrates selected from the group of α-glucans and β-glucans. Glucans are polysaccharides of D-glucose monomers, linked by glycosidic bonds. Non-limiting examples of α-glucans are dextran, starch, floridean starch, glycogen, pullulan, and their derivatives. Non-limiting examples of β-glucans are cellulose, chrysolaminarin, curdlan, laminarin, lentinan, lichenin, oat beta-glucan, pleuran, zymosan, and their derivatives.

### Hydrotrope

The composition of the present invention may optionally comprise from 1% to 10%, or preferably from 0.5% to 10%, more preferably from 1% to 6%, or most preferably from 0.1% to 3%, or combinations thereof, by weight of the total composition of a hydrotrope, preferably sodium cumene sulfonate. Other suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903. Preferably the composition of the present invention is isotropic. An isotropic composition is distinguished from oil-in-water emulsions and lamellar phase compositions. Polarized light microscopy can assess whether the composition is isotropic. See e.g., The Aqueous Phase Behaviour of Surfactants, Robert Laughlin, Academic Press, 1994, pp. 538-542. Preferably an isotropic composition is provided. Preferably the composition comprises 0.1% to 3% by weight of the total composition of a hydrotrope, preferably wherein the hydrotrope is selected from sodium, potassium, and ammonium xylene sulfonate, sodium, potassium and ammonium toluene sulfonate, sodium potassium and ammonium cumene sulfonate, and mixtures thereof.

### Organic Solvent

The composition of the present invention may optionally comprise an organic solvent. Suitable organic solvents include C4-14 ethers and diethers, polyols, glycols, alkoxylated glycols, C6-C16 glycol ethers, alkoxylated aromatic alcohols, aromatic alcohols, aliphatic linear or branched alcohols, alkoxylated aliphatic linear or branched alcohols, alkoxylated C1-C5 alcohols, C8-C14 alkyl and cycloalkyl hydrocarbons and halohydrocarbons, and mixtures thereof. Preferably the organic solvents include alcohols, glycols, and glycol ethers, alternatively alcohols and glycols. The composition comprises from 0% to less than 50%, preferably from 0.01% to 25%, more preferably from 0.1% to 10%, or most preferably from 0.5% to 5%, by weight of the total composition of an organic solvent, preferably an alcohol, more preferably an ethanol, a polyalkyleneglycol, more preferably polypropyleneglycol, and mixtures thereof.

### Amphiphilic Polymer

The composition of the present invention may further comprise from 0.01% to 5%, preferably from 0.05% to 2%, more preferably from 0.07% to 1% by weight of the total composition of an amphiphilic polymer selected from the groups consisting of amphiphilic alkoxylated polyalkyleneimine and mixtures thereof, preferably an amphiphilic alkoxylated polyalkyleneimine.

Preferably, the amphiphilic alkoxylated polyalkyleneimine is an alkoxylated polyethyleneimine polymer comprising a polyethyleneimine backbone having average molecular weight range from 100 to 5,000, preferably from 400 to 2,000, more preferably from 400 to 1,000 Daltons and the alkoxylated polyethyleneimine polymer further comprising:
(i) one or two alkoxylation modifications per nitrogen atom by a polyalkoxylene chain having an average of 1 to 50 alkoxy moieties per modification, wherein the terminal alkoxy moiety of the alkoxylation modification is capped with hydrogen, a C1-C4 alkyl or mixtures thereof,
(ii) an addition of one C1-C4 alkyl moiety and one or two alkoxylation modifications per nitrogen atom by a polyalkoxylene chain having an average of 1 to 50 alkoxy moieties per modification wherein the terminal alkoxy moiety is capped with hydrogen, a C1-C4 alkyl or mixtures thereof; or
(iii) a combination thereof; and

wherein the alkoxy moieties comprises ethoxy (EO) and/or propoxy (PO) and/or butoxy (BO) and wherein when the alkoxylation modification comprises EO it also comprises PO or BO.

Preferred amphiphilic alkoxylated polyethyleneimine polymers comprise EO and PO groups within their alkoxylation chains, the PO groups preferably being in terminal position of the alkoxy chains, and the alkoxylation chains preferably being hydrogen capped. Hydrophilic alkoxylated polyethyleneimine polymers solely comprising ethoxy (EO) units within the alkoxylation chain could also optionally be formulated within the scope of this invention.

For example, but not limited to, below is shown possible modifications to terminal nitrogen atoms in the polyethyleneimine backbone where R represents an ethylene spacer and E represents a C1-C4 alkyl moiety and X— represents a suitable water soluble counterion.

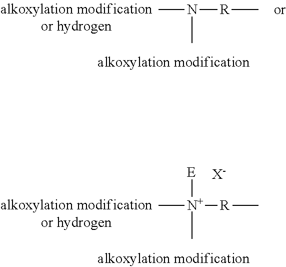

Also, for example, but not limited to, below is shown possible modifications to internal nitrogenatoms in the polyethyleneimine backbone where R represents an ethylene spacer and E represents a C₁-C₄ alkyl moiety and X— represents a suitable water soluble counterion.

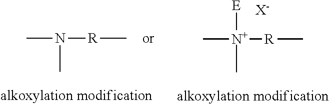

The alkoxylation modification of the polyethyleneimine backbone consists of the replacement of a hydrogen atom by a polyalkoxylene chain having an average of 1 to 50 alkoxy moieties, preferably from 20 to 45 alkoxy moieties, most preferably from 30 to 45 alkoxy moieties. The alkoxy moieties are selected from ethoxy (EO), propoxy (PO), butoxy (BO), and mixtures thereof. Alkoxy moieties solely comprising ethoxy units are outside the scope of the invention though. Preferably, the polyalkoxylene chain is selected from ethoxy/propoxy block moieties. More preferably, the polyalkoxylene chain is ethoxy/propoxy block moieties having an average degree of ethoxylation from 3 to 30 and an average degree of propoxylation from 1 to 20, more preferably ethoxy/propoxy block moieties having an average degree of ethoxylation from 20 to 30 and an average degree of propoxylation from 10 to 20.

More preferably the ethoxy/propoxy block moieties have a relative ethoxy to propoxy unit ratio between 3 to 1 and 1 to 1, preferably between 2 to 1 and 1 to 1. Most preferably the polyalkoxylene chain is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0% to 30% of the polyethyleneimine backbone nitrogen atoms. It is preferred to have less than 30% of the polyethyleneimine backbone nitrogen atoms permanently quaternized. Most preferably the degree of quaternization is 0%.

A preferred polyethyleneimine has the general structure of Formula (II):

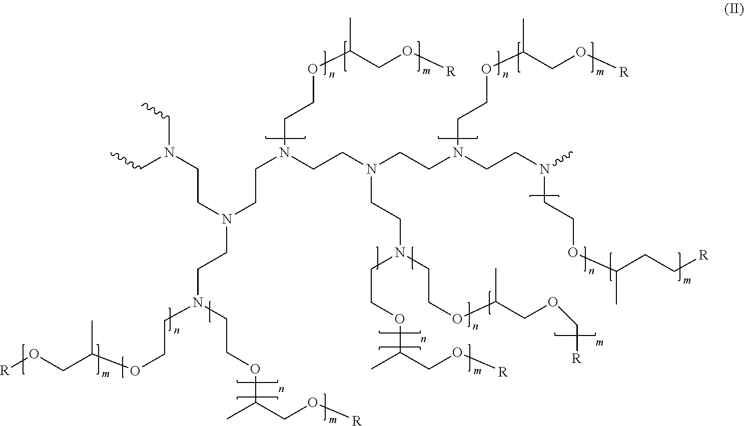

wherein the polyethyleneimine backbone has a weight average molecular weight of 600, n of formula (II) has an average of 10, m of formula (II) has an average of 7 and R of formula (II) is selected from hydrogen, a C₁-C₄ alkyl and mixtures thereof, preferably hydrogen. The degree of permanent quaternization of formula (II) may be from 0% to 22% of the polyethyleneimine backbone nitrogen atoms. The molecular weight of this polyethyleneimine preferably is between 10,000 and 15,000.

An alternative polyethyleneimine has the general structure of Formula (II) but wherein the polyethyleneimine backbone has a weight average molecular weight of 600, n of Formula (II) has an average of 24, m of Formula (II) has an average of 16 and R of Formula (II) is selected from hydrogen, a C₁-C₄ alkyl and mixtures thereof, preferably hydrogen. The degree of permanent quaternization of Formula (II) may be from 0% to 22% of the polyethyleneimine backbone nitrogen atoms. The molecular weight of this polyethyleneimine preferably is between 25,000 and 30,000.

Most preferred polyethyleneimine has the general structure of Formula (II) wherein the polyethyleneimine backbone has a weight average molecular weight of 600, n of Formula (II) has an average of 24, m of Formula (II) has an average of 16 and R of Formula (II) is hydrogen. The degree of permanent quaternization of Formula (II) is 0% of the polyethyleneimine backbone nitrogen atoms. The molecular weight of this polyethyleneimine preferably is from 25,000 to 30,000, most preferably 28,000.

These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like, as described in more detail in PCT Publication No. WO 2007/135645.

### Chelant

The detergent composition herein can comprise a chelant at a level of from 0.1% to 20%, preferably from 0.2% to 5%, more preferably from 0.2% to 3% by weight of total composition.

As commonly understood in the detergent field, chelation herein means the binding or complexation of a bi- or multidentate ligand. These ligands, which are often organic compounds, are called chelants, chelators, chelating agents, and/or sequestering agent. Chelating agents form multiple bonds with a single metal ion. Chelants, are chemicals that form soluble, complex molecules with certain metal ions, inactivating the ions so that they cannot normally react with other elements or ions to produce precipitates or scale, or forming encrustations on soils turning them harder to be removed. The ligand forms a chelate complex with the substrate. The term is reserved for complexes in which the metal ion is bound to two or more atoms of the chelant.

Preferably, the composition of the present invention comprises one or more chelant, preferably selected from the group comprising carboxylate chelants, amino carboxylate chelants, amino phosphonate chelants such as MGDA (methylglycine-N,N-diacetic acid), GLDA (glutamic-N,N-diacetic acid), and mixtures thereof.

Suitable chelating agents can be selected from the group consisting of amino carboxylates, amino phosphonates, polycarboxylate chelating agents and mixtures thereof.

Other chelants include homopolymers and copolymers of polycarboxylic acids and their partially or completely neutralized salts, monomeric polycarboxylic acids and hydroxycarboxylic acids and their salts. Suitable polycarboxylic acids are acyclic, alicyclic, heterocyclic and aromatic carboxylic acids, in which case they contain at least two carboxyl groups which are in each case separated from one another by, preferably, no more than two carbon atoms. A suitable hydroxycarboxylic acid is, for example, citric acid. Another suitable polycarboxylic acid is the homopolymer of acrylic acid. Preferred are the polycarboxylates end capped with sulfonates.

### Adjunct Ingredients

The cleaning composition herein may optionally comprise a number of other adjunct ingredients such as builders (e.g., preferably citrate), cleaning solvents, cleaning amines, conditioning polymers, cleaning polymers, surface modifying polymers, soil flocculating polymers, structurants, emollients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g., carboxylic acids such as citric acid, HCl, NaOH, KOH, alkanolamines, phosphoric and sulfonic acids, carbonates such as sodium carbonates, bicarbonates, sesquicarbonates, borates, silicates, phosphates, imidazole and alike).

### Method of Washing

Other aspects of the invention are directed to methods of washing ware especially dishware with the composition of the present invention. Accordingly, there is provided a method of manually washing dishware comprising the steps of delivering a detergent composition of the invention into a volume of water to form a wash solution and immersing the dishware in the solution. Preferably the diol synthases are present at a concentration from 0.005 ppm to 15 ppm, preferably from 0.02 ppm to 0.5 ppm, in an aqueous wash liquor during the washing process. As such, the composition herein will be applied in its diluted form to the dishware. Soiled surfaces e.g. dishes are contacted with an effective amount, typically from 0.5 mL to 20 mL (per 25 dishes being treated), preferably from 3 mL to 10 mL, of the detergent composition of the present invention, preferably in liquid form, diluted in water. The actual amount of detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. Generally, from 0.01 mL to 150 mL, preferably from 3 mL to 40 mL of a liquid detergent composition of the invention is combined with from 2,000 mL to 20,000 mL, more typically from 5,000 mL to 15,000 mL of water in a sink having a volumetric capacity in the range of from 1,000 mL to 20,000 mL, more typically from 5,000 mL to 15,000 mL. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from 1 to 10 seconds, although the actual time will vary with each application and user. The contacting of cloth, sponge, or similar article to the surface is preferably accompanied by a concurrent scrubbing of the surface.

Another aspect of the present invention is use of one or more diol synthases capable of converting unsaturated fatty acids into oxylipins to provide increased suds longevity in an aqueous wash liquor comprising soil. Preferably the diol synthases are selected from the group consisting of linoleate diol synthases, oleate diol synthases, and mixtures thereof. More preferably, the diol synthases are selected from the group consisting of: linoleate diol synthases (EC 1.13.11.44), 5,8-linoleate diol synthases (EC 1.13.11.60 and EC 5.4.4.5), 7,8-linoleate diol synthases (EC 1.13.11.60 and EC 5.4.4.6), 9,14-linoleate diol synthases (EC 1.13.11.B1), 8,11-linoleate diol synthases, oleate diol synthases, and mixtures thereof, most preferably 5,8-linoleate diol synthases (EC 1.13.11.60 and EC 5.4.4.5), and mixtures thereof.

Another aspect of the present invention is directed to a method of improving suds longevity or grease emulsification in a washing process for washing soiled articles, preferably dishware. The method comprises the steps of: a) delivering a cleaning composition comprising one or more diol synthases of the invention and a surfactant system to a volume of water to form a wash liquor; and b) immersing the soiled articles into said wash liquor. Preferably the diol synthases are present at a concentration from 0.005 ppm to 15 ppm, preferably from 0.02 ppm to 0.5 ppm, in an aqueous wash liquor during the washing process.

### Test Methods

The following assays set forth must be used in order that the invention described and claimed herein may be more fully understood.

### Test Method 1—Glass Vial Suds Mileage Method

The objective of the glass vial suds mileage test method is to measure the evolution of suds volume over time generated by a certain solution of detergent composition in the presence of a greasy soil, e.g., olive oil. The steps of the method are as follows:
1. Test solutions are prepared by subsequently adding aliquots at room temperature of: a) 10 g of an aqueous detergent solution at specified detergent concentration and water hardness, b) 1.0 g of an aqueous protein solution at specified concentration and water hardness, and c) 0.11 g of olive oil (Bertolli®, Extra Virgin Olive Oil), into a 40 mL glass vial (dimensions: 95 mm H×27.5 mm D). For the reference samples, the protein solutions are substituted with 1.0 mL of demineralized water.
2. The test solutions are mixed in the closed test vials by stirring at room temperature for 2 minutes on a magnetic stirring plate (IKA, model #RTC B S001; VWR magnetic stirrer, catalog #58949-012; 500 RPM), followed by manually shaking for 20 seconds with an upwards downwards movement (about 2 up and down cycles per second, +/−30 cm up and 30 cm down).
3. Following the shaking, the test solutions in the closed vials are further stirred on a magnetic stirring plate (IKA, model #RTC B S001; VWR magnetic stirrer, catalog #58949-012; 500 RPM) for 60 minutes inside a water bath at 46° C. to maintain a constant temperature. The samples are then shaken manually for another 20 seconds as described above and the initial suds heights (H1) are recorded with a ruler.
4. The samples are incubated for an additional 30 minutes inside the water bath at 46° C. while stirring (IKA, model #RTC B S001; VWR magnetic stirrer, catalog #58949-012; 500 RPM), followed by manual shaking for another 20 seconds as described above. The final suds heights (H2) are recorded.
5. Protein solutions that produce larger suds heights (H1 and H2), preferably combined with lower drops in suds height between H1 and H2, are more desirable.

### Test Method 2—Sink Suds Mileage Method

The evolution of the suds volume generated by a solution of a detergent composition can be determined while adding soil loads periodically as follows. A stream of hard water (15 dH) fills a sink (cylinder dimensions: 300 mm D×288 mm H) to 4 L with a constant pressure of 4 bar. Simultaneously, an aliquot of the detergent composition (final concentration 0.12 w %) is dispensed through a pipette with a flow rate of 0.67 mL/sec at a height of 37 cm above the bottom of the sink surface. An initial suds volume is generated in the sink due to the pressure of the water. The temperature of the solution is maintained at 46° C. during the test.

After recording the initial suds volume (average suds height×sink surface area), a fixed amount of greasy soil (composition: see Table 1, 6 mL) is injected in the middle of the sink, while a paddle (dimensions: 10 cm×5 cm, positioned in the middle of the sink at the air liquid interface at an angle of 45 degrees) rotates 20 times into the solution at 85 RPM. This step is followed immediately by another measurement of the total suds volume. The soil injecting, paddling, and measuring steps are repeated until the measured suds volume reaches a minimum level, which is set at 400 cm³. The amount of soil additions needed to get to that level is recorded. The complete process is repeated a number of times and the average of the number of additions for all the replicates is calculated for each detergent composition

Finally, the suds mileage index is then calculated as: (average number of soil additions for test detergent composition)/(average number of soil additions for reference detergent composition)×100.

Pending on the test purpose the skilled person could choose to select an alternative water hardness, solution temperature, product concentration or soil type.

TABLE 1
Greasy Soil Composition

| | Weight |
|---|---|
| Ingredient | % |
| Crisco oil | 12.730 |
| Crisco shortening | 27.752 |
| Lard | 7.638 |
| Refined Rendered Edible Beef Tallow | 51.684 |
| Oleic Acid, 90% (Techn) | 0.139 |
| Palmitic Acid, 99+ % | 0.036 |
| Stearic Acid, 99+ % | 0.021 |

### EXAMPLES

The following examples are provided to further illustrate the present invention and are not to be construed as limitations of the present invention, as many variations of the present invention are possible without departing from its spirit or scope.

### Example 1a—Production of Emericella nidulans PpoA

A codon optimized gene (SEQ ID NO: 16) encoding for an Emericella nidulans PpoA variant that includes a C-terminal His-tag (SEQ ID NO: 17) is designed and synthesized and the protein is expressed and purified by Genscript (Piscataway, N.J.). In brief, the complete synthetic gene sequence is subcloned into a pET30a vector. Escherichia coi BL21 (DE3) cells are transformed with the recombinant plasmid and a single colony is inoculated into 2×YT medium containing kanamycin. After Doo reached values over 1, isopropyl β-D-1-thiogalactopyranoside (IPTG) is added (0.1 mM) to induce protein expression and the culture is incubated at 15° C. and 200 rpm for 16 h. Cells are harvested by centrifugation and the pellet is lysed by sonication. After centrifugation, the supernatant is collected and the protein is purified by two-step purification using a nickel affinity column and Q Sepharose column and standard protocols known in the art. The protein is stored in a buffer containing 50 mM Tris-HCl, 150 mM NaCl, and 10% Glycerol at pH 8.0. The final protein concentration is 0.28 mg/mL determined by Bradford protein assay with BSA as a standard (ThermoFisher, Catalog #23236).

### Example 1b—Diol Synthases Detergent Compositions

The evolution of suds volume generated by a certain solution of detergent composition in presence of a soil, i.e., olive oil or greasy soil, is followed over time under specific conditions (e.g., water hardness, solution temperature, detergent concentrations, etc.). The following solutions are prepared:
A. Hard water (15 dH): 0.75 g MgCl₂.6H₂O (Sigma-Aldrich, catalog #M9272), 2.10 g CaCl₂.6H₂O (Sigma-Aldrich, catalog #21108), and 0.689 g NaHCO₃ (Sigma-Aldrich, catalog #31437) are dissolved in 5 L of demineralized water.
B. Detergent solution of a high surfactant content detergent composition (“solution DG-HS”) is prepared using Fairy Dark Green, as commercially available in the UK in February 2017, diluted in hard water (15 dH) prepared as above, at targeted detergent concentration of 0.12%.
C. Detergent solution of a low surfactant content detergent composition (“solution DG-LS”) is prepared using Fairy Dark Green, as commercially available in the UK in February 2017, diluted in hard water (15 dH) prepared as above, at targeted detergent concentration of 0.06%.
D. Protein solutions: Proteins are diluted in demineralized water to the required concentration before proceeding with the suds mileage method.
E. Greasy soil: A grease soil is prepared according to the composition described in Table 1.

### Example 2—Glass Vial Suds Mileage of Emericella nidulans PpoA with Olive Oil

Inventive Compositions A, B and C are examples of detergent compositions according to the present invention, made with: a) detergent solution DG-LS (prepared as described in Example 1b), and b) diluted samples of [symbol] ified Emericella nidulans PpoA (SEQ ID NO: 16) (prepared as described in Example 1a). Comparative Composition D contains the same detergent solution DG-LS in the absence of the enzyme. The glass vial suds mileage test is performed on the compositions using olive oil, as described in the test methods section (Test Method 1).

The initial (H1) and final (H2) measurements are recorded in Table 2. The % suds height drop represents the drop in suds height as measured between the initial and final time point and is calculated by the following equation:

% suds height drop={[(H1−H2)]/H1}*100.

The % suds height drops are calculated for the compositions and shown in Table 2

TABLE 2
Suds Milage

| | PpoA | | | % suds |
|---|---|---|---|---|
| | Concentration in | | | height |
| | Composition | H1 | H2 | drop |
| Composition | [ppm] | [mm] | [mm] | H2 vs H1 |
| Inventive | 12 | 8 | 7 | 12.5% |
| Composition A | | | | |
| Inventive | 1.2 | 6 | 6 | 0% |
| Composition B | | | | |
| Inventive | 0.12 | 5 | 3 | 40% |
| Composition C | | | | |
| Comparative | 0 | 4 | 2 | 50% |
| Composition D | | | | |

Aliquots of Compositions A to D are stored at −20° C. until analysis by LC-MS to determine formation of oxygenated derivatives of oleic acid. Dihydroxy oleic acid is only detected in Inventive Compositions A and B, confirming the activity of the enzyme.

The results in Table 2 confirm that Inventive Compositions A-C detergent solutions comprising Emericella nidulans PpoA enzyme (SEQ ID NO: 16) according to the present invention have a superior suds profile when single variably compared to Comparative Composition D solution without the enzyme, both in view of absolute suds height as in view of suds stability.

### Example 3—Glass Vial Suds Mileage of Emericella nidulans PpoA with Greasy Soil

Inventive Compositions E and F are examples of detergent compositions according to the present invention, made with: a) detergent solution DG-LS (prepared as described in Example 1b), and b) diluted samples of purified Emericella nidulans PpoA (SEQ ID NO: 16) (prepared as described in Example 1a). Comparative Composition G contains the same detergent solution DG-LS in the absence of the enzyme. The glass vial suds mileage test is performed on these compositions using greasy soil, as described in the test methods section (Test Method 1). The initial (H1) and final (H2) measurements are recorded are recorded in Table 3.

TABLE 3
Suds Mileage

| | PpoA | | |
|---|---|---|---|
| | Concentration in | | |
| | Composition | H1 | H2 |
| Composition | [ppm] | [mm] | [mm] |
| Inventive | 1.2 | 11 | 11 |
| Composition E | | | |
| Inventive | 0.12 | 10 | 9 |
| Composition F | | | |
| Comparative | 0 | 5 | 4 |
| Composition G | | | |

The results confirm that Inventive Compositions E and F detergent solutions comprising Emericella nidulans PpoA (SEQ ID NO: 16) according to the invention have a superior suds profile compared to Comparative Composition G solution without the enzyme.

### Example 4: Exemplary Manual Dish-Washing Detergent Composition

Table 4 exemplifies a manual dish-washing detergent composition comprising Emericella nidulans PpoA (SEQ ID NO: 1).

| Ingredient | Wt % |
|---|---|
| Sodium alkyl ethoxy sulfate | 22.91% |
| (C1213EO0.6S) | |
| n-C12-14 Di Methyl Amine Oxide | 7.64% |
| Lutensol ® XP80 | 0.45% |
| (non-ionic surfactant supplied by BASF) | |
| Sodium Chloride | 1.2% |
| Poly Propylene Glycol (MW 2000) | 1% |
| Ethanol | 2% |
| Sodium Hydroxide | 0.24% |
| Asperigullus nidalus PpoA | 0.1% |
| (SEQ ID NO: 1) | |
| Minors (perfume, preservative, dye) + | To 100 % |
| water | |
| pH (@ 10% solution) | 9 |

All percentages and ratios given for enzymes are based on active protein. All percentages and ratios herein are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for manually washing dishware, comprising the steps of:
a. providing a liquid manual dishwashing detergent composition comprising
i) a diol synthase; and
ii) a surfactant system comprising one or more anionic surfactants; and one or more co-surfactants selected from the group consisting of amphoteric surfactant, zwitterionic surfactant, non-ionic surfactant, and mixtures thereof, wherein the weight ratio of the anionic surfactants to the co-surfactants is less than about 9:1;
b. delivering the liquid manual dishwashing detergent composition into a volume of water to form a wash solution; and,
c. immersing the dishware in the wash solution, in the presence of greasy soils comprising unsaturated fatty acids, wherein the diol synthase converts the unsaturated fatty acids into oxylipins to provide improved suds longevity in the wash solution.

2. The method according to claim 1, wherein the diol synthase is present in an amount from about 0.0001% to about 1% by weight of the composition, based on the active protein.

3. The method according to claim 1, wherein the surfactant system is present in an amount from about 1% to about 60% by weight of the composition.

4. The method according to claim 1, wherein the diol synthase is present at a concentration of from about 0.005 ppm to about 15 ppm in the wash solution.

5. The method according to claim 1, wherein the anionic surfactants are present in an amount from about 1% to about 40% by weight of the composition.

6. The method according to claim 1, wherein the anionic surfactants are selected from the group consisting of alkyl sulfate, alkyl alkoxy sulfate, and mixtures thereof.

7. The method according to claim 6, wherein the anionic surfactants are a combination of alkyl sulfate and alkyl ethoxy sulfate with a combined average ethoxylation degree of less than 5 and an average level of branching of from about 5% to about 40%.

8. The method according to claim 1, wherein the co-surfactants are present in an amount from about 0.5% to about 25% by weight of the composition.

9. The method according to claim 1, wherein the amphoteric surfactant is amine oxide surfactant and the zwitterionic surfactant is betaine surfactant.

10. The method according to claim 1, wherein the co-surfactants are amine oxide surfactants, and wherein the anionic surfactants and the amine oxide surfactants are in a weight ratio of between about 4:1 to about 2:1.

11. The method according to claim 1, wherein the detergent composition further comprises a chelant selected from the group consisting of carboxylate chelant, amino carboxylate chelant, amino phosphonate chelant such as MGDA, GLDA, and mixtures thereof.

12. The method according to claim 11, wherein the chelant is present in an amount from about 0.1% to about 20% by weight of the composition.

13. The method according to claim 1, further comprising an amphiphilic polymer.

14. The method according to claim 13, wherein the amphiphilic polymer is present in an amount from about 0.01% to about 5% by weight of the composition.

15. The method according to claim 13, wherein the amphiphilic polymer is an amphiphilic alkoxylated polyalkyleneimine.


SEQUENCE LISTING (17 sequences)

SEQ ID NO: 1 - protein, 1081 aa, Emericella nidulans
MGEDKETNILAGLGNTISQVENVVAASLRPLPTATGDGTYVAESTQTGLAKDLSHVDLKDVRTLAEVVKSAATGEPVDDKQYIMERVIQLAAGLPSTSRNAAELTKSFLNMLWNDLEHPPVSYLGADSMHRKADGSGNNRFWPQLGAAGSAYARSVRPKTMQSPSLPDPETIFDCLLRRKEYREHPNKISSVLFYLASIIIHDLFQTDPKDNSVSKTSSYLDLSPLYGNNQDEQNLVRTFKDGKLKPDCFATKRVLGFPPGVGVLLIMFNRFHNYVVDQLAAINECGRFTKPDESNVDEYAKYDNNLFQTGRLVTCGLYANIILKDYVRTILNINRTDSTWSLDPRMEMKDGLLGEAAAMATGNQVSAEFNVVYRWHACISKRDEKWTEDFHREIMPGVDPSTLSMQDFVAGLGRWQAGLPQEPLERPFSGLQRKPDGAFNDDDLVNLFEKSVEDCAGAFGASHVPAIFKSVEALGIMQARRWNLGTLNEFRQYFNLAPHKTFEDINSDPYIADQLKRLYDHPDLVEIYPGVVVEEAKDSMVPGSGLCTNFTISRAILSDAVALVRGDRFYTVDYTPKHLTNWAYNEIQPNNAVDQGQVFYKLVLRAFPNHFDGNSIYAHFPLVVPSENEKILKSLGVAEKYSWEKPSRISHPIFISSHAACMSILENQETFKVTWGRKIEFLMQRDKHQYGKDFMLSGDRPPNAASRKMMGSALYRDEWEAEVKNFYEQTTLKLLHKNSYKLAGVNQVDIVRDVANLAQVHFCSSVFSLPLKTDSNPRGIFAESELYKIMAAVFTAIFYDADIGKSFELNQAARTVTQQLGQLTMANVEIIAKTGLIANLVNRLHRRDVLSEYGIHMIQRLLDSGLPATEIVWTHILPTAGGMVANQAQLFSQCLDYYLSEEGSGHLPEINRLAKENTPEADELLTRYFMEGARLRSSVALPRVAAQPTVVEDNGEKLTIKAGQVVMCNLVSACMDPTAFPDPEKVKLDRDMNLYAHFGFGPHKCLGLDLCKTGLSTMLKVLGRLDNLRRAPGAQGQLKKLSGPGGIAKYMNEDQSGFTPFPSTMKIQWDGELPQLKEDF

SEQ ID NO: 2 - protein, 1079 aa, Aspergillus fumigatus
MSEKQTGSANGGLGKTLAQLEQVVSASLRPLPSQTGDGTYVTEQVKTGILKDLSHVDLGDLKTLVDVSKSALTGEALDDRKYIMERVIQLSAGLPSTSQIGKELTNTFLTTLWNDLEHPPISYLGRDAMYRRADGSGNNVLWPHIGAAGTPYARSVQPKTVQSPNLPDPETLFDCLLARKEYKEHPNKISSVLFYIASIIIHDLFETDRKDPAISLTSSYLDLSPLYGNNQQEQDLIRTFKDGKLKPDCFSTKRVLGFPPGVGVVLIMFNRFHNYVVEKLAMINEGGRFTKPQESDTAAYAKYDNDLFQTGRLVTCGLYVNIILKDYVRTILNINRTDSIWSLDPRSEMKDGLLGRAAAQATGNQVAAEFNLVYRWHSCISQRDQKWTEDMYQELFPGQDPSKISLQDFLRGLGRWEAKLPGEPRERPFAGLQRKADGSYDDNDLVKIFEESVEDCAGAFGALHVPTVFRSIEALGIQQARSWNLATLNEFRKYFNLAPYKTFEEINSDPYVADQLKRLYDHPDRVEIYPGIIVEDAKESMAPGSGLCTNFTISRAILSDAVALVRGDRFHTVDFTPKHLTNWAYNEIQPQDSVDQTHVFYKLVLRAFPNHFRGDSIYAHFPLVVPSENKKILTKLGTADKYSWDRPNYTPPPQFINSHSACMSILSDQETFKVTWGSKIEFLMRHNNQPYGRDFMLSGDRTPNAMSRQMMGKALYRDKWETEVKRFYENITLKLLHRYSYKLAGVNQVDVVRDIANLAQVHFCASVFSLPLKTESNPRGIFTESELYQIMAVVFTSIFYDADIGKSFELNQAARAVTQQLGQLTLANVELIAKTGFIANLVNSLHRHDVLSEYGVHMIQRLLDSGMPAPEIVWTHVLPTAGGMVANQAQLFSQSLDYYLSEEGSVHLPEINRLAKEDTTEADDLLLRYFMEGARIRSSVALPRVVAQPTVVEDNGQKITLKQGQHIICNLVSASMDPVTFPEPDKVKLDRDMNLYAHFGFGPHQCLGLGLCKTALTTMLKVIGRLDNLRRAPGGQGKLKKLSGPGGIAMYMTPDQTAFFPFPTTMKIQWDGDLPEVKE

SEQ ID NO: 3 - protein, 1071 aa, Aspergillus terreus
MQGIGKAISQLEKVATASLRPLPTETGDGSYVAESTATGLVQDLPHVDLGDLKTLLDVTKNAATGEPIDDKGYVMERLIQLASGLPSTSRNAKQLTSAFLNQLWNDLDHPPVSTVGGEYSHRSADGSGNNILWPGIGAAGSHYARSVQPKTMQSPSLPDPEALFDSLLARKDFKEHPNKISSVLFYIASIIIHDLFQTDHRDSSINRTSSYLDLSPLYGNNQDEQYLMRTFKDGKLKPDCFSSKRILGFPPGVGVLLIMFNRFHNYVVEQLAAVNEGGRFTKPSESNDKEYAKYDNNLFQTGRLVTCGLYINIILKDYVRTILNINRTNSTWSLDPRMDMKDGLLGDAAPLATGNQVSAEFNLIYRWHSCISQRDEKWTTDLYNDIFSDKGQEDIPLNEFMMGVGKWEAGLPQQPAERPFAGLKRKPNGLFDDDDLVTIFKESVEDCAGAFGASHVPTIFKSIESLGIKQARAWNLATLNELRQYFGLTPHKTFEDINSDPYISEQLRRLYDHPDQVEIYPGVIVEETKESMLPGSGLCTNFTISRAILSDAVALVRGDRFYTVDYTPKQLTNWAFTEIQPKDSVDQGHMFHKLVYRAFPNYFKGNSVYAHFPMVVPSENQKILTALGSAEKYSWDKPGFIHPPQFINSHSTCVSILADQETFKVSWGDKIEFLMSNHDKIYGKDFMLSGDRLPNAESRKMMGAALYTDQWEEEVKKFYEKITLKLLKKHSYKIAGVNQVDIVRDVANLAQVNFCANVFSLPLKTEASPRGIFTESELYMIMAAVFAAIFYDADPANSFALNQAAREVTQQLGQVTMANVELIHKTGFISNLVNGLQRHDVLSNYGIHMIQRLLASGLPASEIVWTHLLPTAGGMVANQGQLFSQCLDYYLSEEGSVHLPEINRLAKENTPEADELLLRYFMEGARLRSSVGLPRVVAKPTVIDDNGTKLTLKEGQHILCNLVAASHDPVSFPEPEKVRLDRDMDLYVHFGSGPHKCLGFGLCKLGLTTMLKVVGGLDNLRRAPGPQGQLKRLAGPGGISKYMTADQSGFFPFPTTMKIQWDGDLPEPASD

SEQ ID NO: 4 - protein, 1080 aa, Aspergillus kawachii
MSGSNNHSIVNGIGSTISQVEKAISASLRPLPTATGNGTYVTEPAQTGIVKDLSHVDLTDFKALLEVVKDAVTGQPVDDRHYIMERVIQLAAGLPSTSKSGKDLTNTFLKQLWNDLEHPPISYLGRNTSYRKADGSGNNFLWPHIGAAGSHYARSVRPTTVQSPSLPDPSTLFESLLERKEYKEHPNKISSVLFYLASIIIHDLFQTDRNDYTLNKTSSYLDLSPLYGNNQDEQNLVRSFKDGKLKPDCFSSKRVLGFPPGVGVLLLMFNRFHNYVVENLATINEGGRFTKPDESDVDASTRYDNDLFQTGRLVTCGLYINIILKDYVRTILNINRTDSLWSLDPRADIQDSLLGSAPAEATGNQVSAEFNLVYRWHACVSQRDEKWTQDLYKDLFPGKDPNNVSLPEFLRGVAKWEASLPEQPPDRPFAGLQRNADGAFDDDDLANMFADGVEDCAGAFGAGNIPSVFRNIEALGILQARSWNLATLNEFRKFFDLAPYKTFEEINPDPYIAAQLKNLYDEPDLVEMYPGVIVEATKDAVVPGSGLCTNFTISRAILSDAVSLVRGDRFYTVDYTPKHLTNWAYHEIQPQDSVDQGQVFYKLVLRAFPNHFKGDSIYAHFPLVIPSENKKILEKLSVAQDYSWGRPSYTPTPQFISSNAACISVLNDQEAFKVTWGSKIEFLMRHNNHPYGRDFMLSGDKPPNAASRRMMGSALYRDKWESEVKRFYEDITIKLLRQHSYKLGGTNQVDIVRDVANYAQVHFCANVFSLPLKTESNPRGIFTEAELYEILALVFASIFYDADVGTSFQLNHTARDVTQQLGDLTMANVDFVNKAGFIANIVSSLHRHDVLSEYGEHMIQRLLHNNIPPADIVWTHLLPTAGGMVANQAQLFSQCLDYYLSDEGSVHLPDIKRLAQENTSEADSLLLRYFMEGARLRSSVGLPRLVAKPTVVDDGGSKYTLKPGQSVLCNLVSASMDPRSFPEPEKVKLDRDMSLYAHFGFGPHQCLGMGICKLALTTMLRVVGRLDNLRRAPGSQGQLKRIAGPGGISMYMTADQSSYWPFPSTMKIQWDGDLPSLATN

SEQ ID NO: 5 - protein, 1080 aa, Aspergillus clavatus
MSGKREESTNGGIGKTIAQIEKVVTASLRPLPSKTGDGTYVTEAVKTGLLKDLSHVDLGDLKTLLEVSKSALTGEAVDDKKYIMERVVQLAAGLPSTSQIGKDMTNTFLTTLWNDLEHPPISYLGRDAMYRKADGSGNNILWPHIGAAGTPYARSVRPKTMQSPNLPDPETLFDCLLARKEYKEHPNKISSVLFYIASIIIHDIFQTDRKDPTVSLTSSYLDLSPLYGNNQDEQNLVRTFKDGKLKPDCFSTKRVLGFPPGVGVLLIMFNRFHNHVVENLALINEGGRFTKPQESDAQAYAKYDNDLFQTGRLITCGLYVNIILKDYVRTILNINRTDSIWSLDPRADMKDGLLGEAAAQATGNQVSAEFNLVYRWHSCISKRDQKWTEDMYQEVFPGQDPSKLPLQDFMRGLGRWEAKLPGEPQERPFAGLQRKADGSYDDDDLVKIFGDSVEDCAGAFGVLHVPTVFRSIEALGIQQARSWNLATLNEFRNYFNLAPYKTFEEINPDPYVADQLRRLYDHPDRVEIYPGIIVEDTKESMAPGSGLCTNFTISRAILSDAVALVRGDRFHTVDFTPKHLTNWAYNEIQPQESVDQTHVLYKLVFRAFPNHFKGDSIYAHFPLVIPSENKKILTKLGTADKYSWDRPSFTHPPQFINSHSACMSILADQETFKVSWGKKIEFLMRHNDQPHGRDFMLSGDKPPNAESRQMMGKALYRNKWETEVKDFYEEITLKLLHRNSYKLAGTNQVDIVRDVANLAQVYFCASVFSLPLKTESNPRGVFTESELYQIMAVVFTSIFYDADVCKSFELNQGARAVTQQLGQLTMANVELIEKTGFIANLVNSLHRHDALTEYGVHMIQRLLDTGTPAAEIVWTHVLPTAGGMVANQAQLFSQCLDYYLSDEGSIHLPEINRLAKQDTPEADDLLLRYFMEGARLRSSVALPRVVAQPTVVEDNGQKVILKEGQHILCNLVSASMDPASFPEPDKVKLDRDMNLYAHFGFGPHQCLGIGLCKLALTTMLKVVGRLDNLRRAPGGQGRLKKLSGPGGIAMYMTPDQSGFFPFPTTMKIQWDGDLPPLKTE

SEQ ID NO: 6 - protein, 1080 aa, Aspergillus niger
MSGANNHSIVNGIGSTISQVEKAISASLRPLPTATGNGTYITEPDQTGIVKDLSHVDFTDIKALLEVIKDAVTGQPVDDRHYIMERVIQLAAGLPSTSKNGKDLTNAFLKQLWNDLEHPPISYLGRDSSYRKADGSGNNFLWPHIGAAGSHYARSVRPTTVQSPSLPDPSTLFASLLERKEYKEHPNKISSVLFYLASVIIHDLFQTDRSDFTLNKTSSYLDLSPLYGNNQDEQDLVRTFKDGKLKPDCFSSKRVLGFPPGVGVLLLMFNRFHNYVVENLATINEGGRFTKPDESDVDASTKYDNDLFQTGRLVTCGLYINIILKDYVRTILNINRTDSLWSLDPRADIQDSLLGSAPAEATGNQVSAEFNLVYRWHACISQRDEKWTQDLYKDLFPGKDPNNVSLQEFIRGVAKWEASLPEQPPDRPFAGLQRNADGAFDDGDLANMFADGVEDCAGAFGAGNIPSVFRNIEALGILQARSWNLATLNEFRKFFDLAPYKTFEEINPDPYIAAQLKNLYDEPDLVEMYPGVIVEATKDAIVPGSGLCTNFTISRAILSDAVSLVRGDRFYTVDYTPKHLTNWAYNEIQPQDSVDQGQVFYKLVLRAFPNHFKGDSVYAHFPLVIPSENKKILEKLSVAQDYSWGRPSYTPLPQFISSNAACISVLNDQEAFKVTWGSKIEFLMRHNNHPYGRDFMLSGDKPPNAASRRMMGSALYRDKWESEVKRFYEDITIKLLRQHSYQLGGVNQVDIVRDVANYAQVHFCANVFSLPLKTESNPRGIFAESELYEILALVFASIFYDADVGTSFQLNQTARDVTQQLGELTMANVDFVNKAGFIANLVSSLHRHDVLSEYGEHMIQRLLHSNVPPAEIVWTHLLPTAGGMVANQAQLFSQCLDYYLSDEGSIHLPDIKRLAKENTSEADALLLRYFMEGARLRSSVGLPRLVAKPTVVDDGGSKYTLKPGQSVLCNLVSASMDPRSFPEPEKVKLDRDMSLYAHFGFGPHQCLGMGICKLALTTMLRVVGRLDNLRRAPGSQGQLKKIAGPGGISMYMTADQSSYWPFPSTMKIQWDGDLPSLATN

SEQ ID NO: 7 - protein, 1127 aa, Glomerella cingulate
MSQQSHTEQFPKNQPPLAERLASARQLVTKAISAVPPHPEPLPSPNSDQGEPSNLLQDVKKLGFDDFDTLVHFFSSAVEGQINDNELLLENLIQLFAKLPQNSVKGKRLENGLINQLWNGIDHPPMTTLGEDHKYRAADGSGNAIHDPKMGAAGQPYARSTPAKSYQNPNQPEPEMIFDMLFARGGEFKPHPNKISSFMFYLATIITHDIFQTKNGTSPINQTSSYLDLAPLYGRNQAEQDLMRTKKNGLLKPDTFSSKRVLGFPPGVGTLLIMFNRYHNYVATNLATINEGGRFQKPTGDDPEKTAKYDNDLFQTARLITCGLYVSIILRDYVRTILGMNRTASSWALDPRTNEGKSILSQQTPEGTGNQVSVEFNLIYRWHNTISPKDEQWTKDVMKKVLGKDPTEMSLMEFGHAMRDWEQEIPDDPAQRGFMDLPRNADGTLNEADLAKIFKESVDDVAGSYGANRIPEVMRPIELMGIMASRSWNCATLNEFREHFGLTRHPTFEDINPDKEVAAKLRFLYGSPDAVELYPGLMAEKAKPPMAPGSGLCGNFTMTRAILSDAVALVRGDRFYTIDYTPKNLTNWGFNQASYDLNVDQSHVLYKLVFRAFPNSFQNNSIYAHFPFVIPSENKKILESIDKAYLYTWDEPKTKTPLIPILSHKAVSEVLYNQQDFKVITGDAINHLVAQPNKPHYGKDFCLSGDGKEHAKNRTLVRKSLISGPWETEIWKWYTHMTPKILNLNSFPIPGNKREIDLVRDVINVTNTRFNAALFCMPIKNEESPWGVYTDQELYSVLGALFQAVFMDADIGNSFKLRTIARELAQDLGKVVMLIAQTIKKAGLITDIVAKIREGEASLPTYGNHLIERMLSDGKDVEEVVWGTIMPVITANVANQSQVTSLCVDYYLDKEGKKHLPELYRLAHENTPEADETLLKYMLEGCRLRGPVAVYREATSTQVITDYSPCLPSESDPTGRDPITNPDIEGTKREVKIPRGYRVVCNFATAGRDPAIFEDPNEVRLDRPLDSYVHFGLGPHWCAGKEMSRVGQTSLFKQIVGLKNLRRAPGGRGEMKNFPASPWNGQVGLPVEGQNGSAAHQQPWLGLRAFMTVDQSSLWPIPTTMRVQWDE

SEQ ID NO: 8 - protein, 1165 aa, Gaeumannomyces graminis
MTVSTHHDDSPGLSGRLRDLLHHVFGNQKSPTVYPNAPGNSAKPVPTGLADDIDKLGFKDIDTLLIFLNSAVKGVNDDQQFLLEKMIQLLAKLPPASREGKKLTDGLINDLWDSLDHPPVASLGKGFSFREPDGSNNNIHLPSLGAANTPYARSTKPLVFQNPNPPDPATIFDTLMVRDPAKFRPHPNKISSMLFYLATIITHDIFQTSPRDFNINLTSSYLDLSPLYGRNHDEQMAVRTGKDGLLKPDTFSSKRVIGFPPGVGAFLIMFNRFHNYVVTQLAKINEGGRFKRPTTPDDTAGWETYDNSLFQTGRLITCGLYINIVLGDYVRTILNLNRANTTWNLDPRTKEGKSLLSKPTPEAVGNQVSVEFNLIYRWHCTISERDDKWTTNAMREALGGQDPATAKMEDVMRALGMFEKNIPDEPEKRTLAGLTRQSDGAFDDTELVKILQESIEDVAGAFGPNHVPACMRAIEILGIKQSRTWNVATLNEFRQFIGLTPHDSFYHMNPDPKICKILAQMYDSPDAVELYPGIMAEAAKPPFSPGSGLCPPYTTSRAILSDAVSLVRGDRFYTVDYTPRNITNWGFNEASTDKAVDWGHVIYKLFFRAFPNHFLPNSVYAHFPFVVPSENKLIFEGLGAANKYSWDPPKARAPIQFIRSHKAVLEVLSNQKDYKVTWGPAIKMLSGDPATSFALAGDEPANAASRHHVIAALTAPKQWRDEVRRFYEVTTRDLLRRHGAPVHGVGAGPRTHEVDVIRDVIGLAHARFMASLFSLPLKEEGKEEGAYGEHELYRSLVTIFAAIFWDSDVCNSLKLHQASKAAADKMSALIAEHVREMEAGTGFLGALGKLKDLITGNDVHANGNGVYTNGNGVYTNGNGVHTNGNGVHTNGNGVPHAAPSLRSFGDQLLQRMLSQDGRSIEETVSGTILPVVMAGTANQTQLLAQCLDYYLGVGEKHLPEMKRLAMLNTSEADEKLLKYTMEGCRIRGCVALYRAVVTDQAVDDTIPCIPNKDDPTFARPLSNPQVAESARTLKLSTGTRMLVDLTTASHDPAAFPDPDEVRLDRPLESYVHFGLGPHRCAGEPISQIALSSVMKVLLQLDGLRRAAGPRGEIRSYPASQWPGQAGRPPRDPAWSGLRTFTSADQSAFSPLATTMKINWEGRGDL

SEQ ID NO: 9 - protein, 1171 aa, Magnaporthe oryzae
MASSSSSGSSTRSSSPSDPPSSFFQKLGAFLGLFSKPQPPRPDYPHAPGNSAREEQTDITEDIQKLGFKDVETLLLYLNSSVKGVNDDKQLLLERLIQLLSKLPPTSTNGKKVTDGLITGLWESLDHPPVSSLGEKYRFREADGSNNNIHNPTLGVAGSHYARSAKPMVYQNPNPPAPETIFDTLMARDPAKFRPHPNQISSVLFYFATIITHDIFQTSSRDPSINLTSSYLDLSPLYGRNLEEQLSVRAMKDGLLKPDTFCSKRVHGFPPGVGVLLIMFNRFHNYVVTSLAKINEGNRFKKPVGDDTAAWEKYDNDLFQTGRLITCGLYVNIVLVDYVRTILNLNRVDSSWILDPRTEEGKSLLSKPTPEAVGNQVSVEFNLIYRWHCGMSQRDDKWTTDMLTEALGGKDPATATLPEFFGALGRFESSFPNEPEKRTLAGLKRQEDGSFEDEGLIKIMQESIEEVAGAFGPNHVPACMRAIEILGMNQARSWNVATLNEFREFIGLKRYDTFEDINPDPKVANLLAEFYGSPDAVELYPGINAEAPKPVIVPGSGLCPPSTTGRAILSDAVTLVRGDRFFTVDYTPRNLTNFGYQEAATDKSVDNGNVIYKLFFRAFPNHYAQNSIYAHFPFVIPSENKKIMESLGLADKYSWQPPQRKPATQMIRSHAAAVKILNNQKDFKVVWGESIGFLTKFPTGENPGLGFALAGDAPANQQSRDQLMKCIFSPKAWEDEVRQFCEATTWDLLRRYSAKVQDKGPHLKVHTHEIDVIRDVISLANARFFAAVYSLPLKTENGDDGVYSDHEMYRSLMLIFSAIFWDNDVSKSFKLRRDARAATQKLGALVEKHIVEMGSLFHSFKHSHSAVSDKTNGLANGGANGHANGNANGHTNGNGIHQNGGAAPSMLRSYGDLMLRRMIEAYGEGKSVKEAVYGQIMPSIAAGTANQTQIMAQCLDYYMSDDGAEHLPEMKRLASLETPEAFNTLMKYLFEGARIRNTTAVPRLVATDQTVEDNIPCLPDPKDSTFLRPIPNPQQAETTRTVKLSRGSMVLVDLTVAAHDATAFPDPEKVRLDRDLDSYTFFGLGPHRCAGDKVVRITMTAVFKVLLQLDGLRRAEGGRGVFKSLPASQWNGQAGRVAGEKPQWSGLRTYVNADESAFSQTPMNMKIRWDD

SEQ ID NO: 10 - protein, 1079 aa, Penicillium oxalicum
MVGHHGSETHGEKSPLVQIEQVFKAALRPLPTETGDGTYVKDTKLTGLAQDLSHVDLVDVKTLADVAKNAITGEAMNDREYIMERVIQLAAGLPTTSKNGRDLTNTFLSTLWNDLQHPPTSYLGRDSAYRQADGSGNNPFWPNIGAAGTPYARSVRPQTMQPGALPEPETLFDSLLARQKFKEHPNKISSVLFYLASIIIHDLFQTDPRNPTVSLSSSYLDLGPLYGNNQDEQNAVRTFKDGKLKPDCFSSKRILGFPPGVGVLLIMFNRFHNYVAEQLAQINEGGRFTKPAESNTKAYATWDNDLFQTSRLVTCGLYVNIILKDYVRTILNINRTDSTWSLDPRAEMKDGVLSHAAKQATGNQVSAEFNLVYRWHSCISARDQQWSEDLYRELFNGQDPNTLSTQQFIMGVGRWEGTLPQDPMERPFAKLQRQADGRFSDDDLVRFFEESVEDVAGAFGASNVPTVFRTIEVLGIKQARSWNLATLNEFRSFFNLQPYKTFEEINSDPYIADQLRHLYDHPDQVELYPGLVVEDAKEPMLPGSGLCTNYTTSRAILSDAVTLVRGDRFYTVDYTPKHLTNWAFNEISYDDSVDNGAIFYKLVLRAFPNHVRGDSVYAHFPMVVPSENKKILTSLGKSEKYSYSRPTYTPPPRMIKSHGACMSILADKETFKVTWGQKLEFILSRDGHSYGGDFMLSGDKAPHAQSRKMIGNALYRDQWKSEVRSFYESITLQLLRQKSYKLAGVNQVDIVRDVSNLAQIHFCANIFSLPLKTESNPHGVFTEQELYEIMALVFTCIFYDVEVTKSFQLEQASRQVAQQLGELVMANVDLVSKSGFVADIISRLRRHEHLTDYGVHMIQRLLDSGLPPKEIVWTHILPSASSMVANQAQLFIQCLDFYLKPENAHHLADIQRLSKEDTPESDELLLRYFMEGGRICSSVALPRVVAKSTVIEDNGEQVSLKEGEAIFLNLVSASHDPKAWPDPEEVRLDRDLNQYAHFGFGPHQCLGLGVCQVALPTMLRVVGQLQNLRRAPGLQGQLKKLPALGGLTMYMDADHSSISPYPSTMKIQWDGELPKARYT

SEQ ID NO: 11 - protein, 1074 aa, Penicillium chrysogenum
MAEKESNSSGKIAQLEQVVAAALRPLPTQTGDGSYVQEPTVTGLAKDLLNFDLKDAKTLADMAKTAVTGKAVNDRDYIMERVIQLASGLPSTSRNGKELTNTFLTQLWGDLEHPPISYLGRDAAYRKADGSGNNTFWPQIGAANTPYARSVRPKTMQPVALPEPEALFDSLLARKDFKEHPNKISSVLFHLASIIIHDLFQTDPRDQTKSLTSSYLDLSPLYGNNQKEQDTVRAFKDGKLKPDCFSTKRVLGFPPGVGVILIMFNRFHNSVVTQLAAINEGGRFTKPDESNAEAYATWDNDLFQTARLVTCGLYINIILKDYVRTILNVNRTDSLWSLDPRADIRDGLLGEAPAQATGNQVSAEFNLVYRWHSCVSSRDEKWSEDLYKEIFDGKDPKEISMQQFTGGLRQWESKLPADPQERPFAKLQRQADGKFDDNDLVKIFEESVEDPAGAFGALNVPDVFRGIEVLGIKQARSWNLATLNEFRQYFGLAAYQTFEEINPDPYVANQLKHFYDHPDLVELYPGLVVEETKQAMTPGSGLCTNFTTSRAILSDAVALVRGDRFYTVDFTPKHLTNWAFNEINNDVSVDGGQVFYKLILKAFPNHFRGDSVYAHFPLVVPDENKKILTSLGKVKTYSFDRPFYKAPPLFINSHSACTKILKDQEGFKVVWGEKIQFLMENSGRPYGRDFALSGDLPANAASRKMIGAALHRDKWESEVKAFYEDITLKLLERNSFKVAGVNQVDIVRDVAVLAQVNFCANVFSLSLKTESNPRGVFSEQELYQILAVIFASIFYDVDVSKSLQLCQTARNVAQQLGELTLANVELVAKTGFISNLVNRLHRHDILSEYGIHMIQRLLDSQLPVKDVVWSHILPTAGALVANQGQLFSQCIDYYLSEEAAEHLAEIQRLSREDTPEADELLVRYFMEGARLRCSVALPRFATKPTVVDDNGKRVTLKAGQEIICNLVVAGRDPVAFPDPDKVRLDRDMSLYTHFGFGPHECLGVKMCPLALSTMLKVLGRLDNVRRAPGPQGHLKRLDGLGGIAMYMDAEHSSFSPFPMTMKIQWDGDLPARRE

SEQ ID NO: 12 - protein, 1121 aa, Penicillium digitatum
MLRRISTQFKRSKDLKDSKDFKDSNGENTENSTEKNSKRASKVSPTRKSFSAKEEHHVVKRAEVVAVFEKFAQAIHASKEPLPNQTSDGAYLKHDKSSGLINDIKSLGFRELNTVKDLIASKASGELVDDKTYLMERIIQMVADLPGNSKNRTELTSLFLDELWNSIPHPPLSYMGDEYKYRSADGSNNNPTLPWLGAANTAYCRTIPPLTIQPSGLPDAGLIFDTLFARQEFTPHPNKVSSVFFDWASLIIHDIFQTDYRQQHLNKTSAYLDLSILYGDVQEQQDLIRSHQDGKLKPDCFSEGRLQALPAACGVLLVMLNRFHNHVVTQLAEINENGRFSKPRPGLSEEDAKKVWTKRDEDLFQTGRLITCGLYINITLYDYLRTIVNLNRTNSTWCLDPRAQVEKAGATPSGLGNQCSVEFNLAYRWHSTISQGDEKWIEQIYHDLMGKPAEEVTMPELLMGLKKVEGLLDTDPAKRTFARLQRNEDGFFNDGELVNILTHATEDVASSFGPRNVPKAMRSIEILGIEASRRWNVGSLNEFRKHFGLKPYETFEEVNSNPEISNTLRHLYDHPDFIELYPGIVTEEAKEPMIPGVGIAPTYTISRAVLSDAVALVRGDRHYTIDYNPRNLTNWGYNECRYDLNINQGCIFYKLATRAFPNHYRPDSIYAHYPMTIPSENRNIMKDLGREQDYSWDKPAFIEPRVNLASHQNAKLLLENQRDFRPSWARSVSELFGKGEFDTKQREAIGKALNTEDFPKLVKTFYEDITERLIVEKGGQLGKINQIDITRDVGNLAHVHFASTIFGIPLKTEQSPQGLFTEHEMYMILSTIFSALFFDVDAPRSYALNHAASAVSTQLGQVVEATVKADTNSGLFSGIMDSFRPHDNALREFGTEAVRRMKEAGSSASDITWSAIIPTIVGLVPSQGQVFTQIIEFYTAPENQAHLAAIHSLTKTDSAESDEKLHRYCLEAIRLNGTFGAFREAKEAVTIEEDGKVYAVQPGQQVFASFNQANHDPSVFPEPYQVNLHRPLNSYINHGQGPTTGFGEQITKIALVAMLRVVGRLQGLRRAAGAQGQLQKIPQEGGYYVYLRGDGAAYCPFPMSLKLHWDGPVGQKKTPSS

SEQ ID NO: 13 - protein, 773 aa, Nostoc sp. PCC7120
MDLNTYLKLLNLLDSESQKIMLELQAMFSAAGLALRGRGTHTDGIIVKGNLTVLHSSDVPSHSLFTPGKKYDVIFRHANIVGGAKDDALINGRGSAIRIGNIGDDLSKPRLLDLVLNTGEVFGLPTARLYHQFFGSDFHQKSDMLASGSLRRYAVEAALRNPDSFTELYYHTQLCYEWVDSKKKSRYARFRLLNPNQSTEGGLLDDSVEIGPRLVLPRKRGDTREKNYLRNEFRQRLTDGNIVEYVLQAQFRSIEDVAVDCSNIWDPNTYPWLDIAAIVLNQDESENDYYQEIAYNPGNTHYDLKLPNSYSVDDFASLGVSGALVHYFGSIVRAERTQYLYGSKDDLPGKPVYFPLPVTEIPSKRFLFLLEKYNFLTDNSYPSDGEHDKIEALVSAMPTTALDLAVGTTDPTDIPDSYFLERRLNGYNPGAIRESSGQEGWTHELTHNLAKYDIKPGLHFPDFVQCRLFVDKQNGVKLHSIKIDDHEITPCQEQWQYAKRTYLQAEFLSQELKLHLARCHFNIEQYVMAIKRRLAPTHPVRAFINPHLEGLIFINSSAVPKIIGSTGFIPIASMLTQGSIVDVMKNELSKLSYMWNPIADLPRDIPGDLFTPAATAYWELLNNYVEQGLLQPFEDELRTEVNAIQVDELFAELKERSLYSGDQPPKYDSSELKSLLMYIIYHSSFLHSWANFKQYDDAGNPNHVSMGDYSQYDQQTQDKIRFSQRSLTWVLSSIRYNSVAVYGSDLLKQLIREKSSILEPGLPLEDLMMSINI

SEQ ID NO: 14 - protein, 805 aa, Acaryochloris marina
MDSRDPRTEHVDDEFKKLISNIARAFGRTAQIKGRRATHSYGTVAKGVLKVLDTLDIPQHQIFSAGKQYPVLLRHANIKGFRDDAILDGRGATVRVLAGDAQAPLSDLNLDEGIVDILMSTGRSFILAEALSFARWAAGPMKSRAAMLQEFPKIAPIFHEIIRDPDSYTQLHYYSETTYSFTSLNQQSFFLRYRLVNRQNPSADTGWLKPEEVKLPLDYLPRVASDTRPETYLQDDFRQQVRSTGVSYLLQIQLQPVSDDAAMNETAKDCTIPWEEEDHPFHDVAVLDLGSILPDELAEALEFNPYNAPPELSLILAKTARETASVNHLRSVVYQISANMRKYQTPSSSLVDWGSGHQPSLPEQYPYGTGKTPSFDNTKPLPARVKPKPRYWANFGLKLIPNQQLDPDLPELGITGALDLMGTSVVSYMPPNLTRTRLDKFSDDFFVERRLNGFNPGKLNRVTGHAWQYQVCYDCSKHQVEPAGILPTKITARFNFCGQYLHPHSIQFTLNGQTETQQPGDENWEWSKRLFRCAEFVFQEAQSHLGRTHMNLDQYAMAYYRNVVNNPIRLLLEPHLEGLLSINKLGANLISGPTGFIPEASSLTPESVDDVLKDEISHLSYHWTPHRQTLPDRVLNNHYDPAAIAMWNLLTQYVREFFEDHQAGMEEYWSEIQAMSHDLVTHSILKPELGTLAVQNNADLQQLCVYVIFLSSFFHSWVNNKQYEDGGDVSYSTIGLWDTRHPKYDPLRVAEREAKQVTLLWTLSHVRYNPIMDVGPTALKNLLWQQRQHIEPGIPLANLMMSTNI

SEQ ID NO: 15 - protein, 822 aa, Nostoc sp. NIES-4103
MTNEIQNPVDHLVGDPRVRDIEPKFSKIISDIARVFGQMAQLKGRRATHSFGTVAKGVLEVVKQPDIPPHRLLEAGKKFPVLLRHANIKGFRDDAILDGRGATLRILNGPADAPITALDLHTPILDVLMSTGRCFILPDAASFSRWVASPLQDRAKLLVEFPKITPIFAEIIRNPDSYTKLHYYSETTYLFIGLDGKQYYLRYRLINSDRSADTGFINSADLRLPLDYLPRLEDDTRPETYLQNDYQQKVKNGGVKYILQFQLRAVSDNQAANEEAKDCTIPWDETQYPCKDVAVISLTEIVPSELAEPLEFNPYHAPPDLSLILAHSINETASVNHLRSVVYQISANMRKFQQPSAELVDWGIKGNQPDPKQVYTYYGQIGQDIPRYDFRRPLPDRVKPKPRYIANFGLHLFPARPLGSIPMLGIVGVAETMQALGQTAPQWMPANLTRTRPDKYEDQFFVERRLNGFNPGKFNRVHTFEPWQYTIRYDCRKYKVEEAGILPAEIEARFKFEDHNLHLHSIKFILNGKTETHKPGDADWEWSKRLFRTAEFVFQEIQSHLGRTHMNLDQYAMAYYRNVVNNPIRLLLEPHFDGLLNINSLGAALILGATGFIPEASSLSPEEVDIVLKDEISRLSYRNWSPHIQALKDEVQNNHFDRAALSVWEAIEEYVSEFFQKQEAGIKAYWSEIGGMSEDLVKHSVLGQKSQSLAIANINDLKQLCIYVIYLSSFFHSWVNNKQYDDGGDPAYASIGLWDGHNPQYNPITVAEKHARQVTLLWTLSSVRYNPVMEVGPPALKDRLWKRRKIIQPGIPVESIMMSTNI

SEQ ID NO: 16 - DNA, 3261 bp, Artificial Sequence
  codon optimized artificial DNA sequence
atgggcgaagacaaggagaccaacattctggcgggtctgggcaacaccatcagccaggtggaaaacgtggttgcggcgagcctgcgtccgctgccgaccgcgaccggtgatggcacctatgttgcggagagcacccaaaccggtctggcgaaagacctgagccacgttgatctgaaggacgtgcgtaccctggcggaagtggttaaaagcgcggcgaccggtgaaccggtggacgataaacagtacattatggaacgtgttatccagctggcggcgggtctgccgagcaccagccgtaacgcggcggaactgaccaagagcttcctgaacatgctgtggaacgatctggagcacccgccggttagctatctgggtgcggatagcatgcaccgtaaagcggacggtagcggcaacaaccgtttttggccgcagctgggtgcggcgggtagcgcgtacgcgcgtagcgttcgtccgaaaaccatgcaaagcccgagcctgccggatccggagaccatctttgactgcctgctgcgtcgtaaagaatatcgtgagcacccgaacaagattagcagcgtgctgttctacctggcgagcatcattatccacgacctgtttcagaccgatccgaaagacaacagcgttagcaagaccagcagctacctggatctgagcccgctgtatggcaacaaccaggacgaacaaaacctggtgcgtaccttcaaggatggcaagctgaaaccggactgcttcgcgaccaaacgtgttctgggctttccgccgggtgttggcgtgctgctgatcatgttcaaccgttttcacaactacgtggttgatcagctggcggcgattaacgagtgcggtcgtttcaccaagccggatgaaagcaacgtggacgagtacgcgaaatatgataacaacctgtttcaaaccggtcgtctggtgacctgcggcctgtacgcgaacattatcctgaaggactatgttcgtaccattctgaacatcaaccgtaccgatagcacctggagcctggacccgcgtatggaaatgaaagacggtctgctgggtgaagcggcggcgatggcgaccggtaaccaagttagcgcggaattcaacgtggtttaccgttggcacgcgtgcattagcaagcgtgatgaaaaatggaccgaggacttccaccgtgagatcatgccgggcgtggatccgagcaccctgagcatgcaggactttgttgcgggtctgggccgttggcaagcgggtctgccgcaagaaccgctggagcgtccgtttagcggtctgcagcgtaagccggatggcgcgttcaacgacgatgacctggtgaacctgtttgagaagagcgtggaggactgcgcgggtgcgtttggtgcgagccatgtgccggcgatttttaagagcgttgaagcgctgggtatcatgcaggcgcgtcgttggaacctgggcaccctgaacgaattccgtcaatactttaacctggcgccgcacaagaccttcgaggatattaacagcgacccgtacatcgcggaccagctgaaacgtctgtatgatcacccggacctggtggagatctacccgggcgtggttgtggaggaagcgaaagatagcatggttccgggtagcggcctgtgcaccaacttcaccattagccgtgcgattctgagcgatgcggttgcgctggtgcgtggtgatcgtttttacaccgtggactataccccgaagcacctgaccaactgggcgtataacgaaatccagccgaacaacgcggttgatcagggccaagtgttctacaaactggttctgcgtgcgttcccgaatcactttgacggtaacagcatttatgcgcactttccgctggttgtgccgagcgagaacgaaaagatcctgaaaagcctgggcgtggcggaaaaatacagctgggagaagccgagccgtattagccacccgattttcatcagcagccacgcggcgtgcatgagcatcctggaaaaccaggagaccttcaaagttacctggggtcgtaagattgaatttctgatgcagcgtgataaacaccaatatggcaaggatttcatgctgagcggtgaccgtccgccgaacgcggcgagccgtaagatgatgggcagcgcgctgtatcgtgacgagtgggaagcggaagtgaaaaacttttacgagcaaaccaccctgaagctgctgcacaaaaacagctacaagctggcgggtgttaaccaggtggatatcgttcgtgacgtggcgaacctggcgcaagtgcacttctgcagcagcgtttttagcctgccgctgaagaccgacagcaacccgcgtggcattttcgcggaaagcgagctgtataaaatcatggcggcggttttcaccgcgatcttctacgatgcggacatcggcaagagctttgaactgaaccaagcggcgcgtaccgtgacccagcaactgggtcaactgaccatggcgaacgttgagattatcgcgaaaaccggcctgatcgcgaacctggtgaaccgtctgcaccgtcgtgatgttctgagcgaatatggtattcacatgattcaacgtctgctggacagcggtctgccggcgaccgagattgtttggacccatatcctgccgaccgcgggtggcatggttgcgaaccaggcgcaactgttcagccaatgcctggattactatctgagcgaggaaggtagcggccacctgccggaaatcaaccgtctggcgaaggagaacaccccggaagcggatgagctgctgacccgttactttatggaaggtgcgcgtctgcgtagcagcgtggcgctgccgcgtgttgcggcgcagccgaccgttgtggaagataacggcgagaaactgaccattaaggcgggccaagttgtgatgtgcaacctggttagcgcgtgcatggatccgaccgcgttcccggacccggagaaggttaaactggatcgtgacatgaacctgtatgcgcacttcggttttggcccgcacaaatgcctgggtctggatctgtgcaagaccggcctgagcaccatgctgaaagttctgggtcgtctggataacctgcgtcgtgcgccgggtgcgcagggtcaactgaagaaactgagcggtccgggtggcatcgcgaaatacatgaacgaggaccagagcggcttcaccccgtttccgagcaccatgaagattcagtgggatggtgaactgccgcaactgaaagaggactttcatcatcaccatcaccac

SEQ ID NO: 17 - protein, 1087 aa, Emericella nidulans
MGEDKETNILAGLGNTISQVENVVAASLRPLPTATGDGTYVAESTQTGLAKDLSHVDLKDVRTLAEVVKSAATGEPVDDKQYIMERVIQLAAGLPSTSRNAAELTKSFLNMLWNDLEHPPVSYLGADSMHRKADGSGNNRFWPQLGAAGSAYARSVRPKTMQSPSLPDPETIFDCLLRRKEYREHPNKISSVLFYLASIIIHDLFQTDPKDNSVSKTSSYLDLSPLYGNNQDEQNLVRTFKDGKLKPDCFATKRVLGFPPGVGVLLIMFNRFHNYVVDQLAAINECGRFTKPDESNVDEYAKYDNNLFQTGRLVTCGLYANIILKDYVRTILNINRTDSTWSLDPRMEMKDGLLGEAAAMATGNQVSAEFNVVYRWHACISKRDEKWTEDFHREIMPGVDPSTLSMQDFVAGLGRWQAGLPQEPLERPFSGLQRKPDGAFNDDDLVNLFEKSVEDCAGAFGASHVPAIFKSVEALGIMQARRWNLGTLNEFRQYFNLAPHKTFEDINSDPYIADQLKRLYDHPDLVEIYPGVVVEEAKDSMVPGSGLCTNFTISRAILSDAVALVRGDRFYTVDYTPKHLTNWAYNEIQPNNAVDQGQVFYKLVLRAFPNHFDGNSIYAHFPLVVPSENEKILKSLGVAEKYSWEKPSRISHPIFISSHAACMSILENQETFKVTWGRKIEFLMQRDKHQYGKDFMLSGDRPPNAASRKMMGSALYRDEWEAEVKNFYEQTTLKLLHKNSYKLAGVNQVDIVRDVANLAQVHFCSSVFSLPLKTDSNPRGIFAESELYKIMAAVFTAIFYDADIGKSFELNQAARTVTQQLGQLTMANVEIIAKTGLIANLVNRLHRRDVLSEYGIHMIQRLLDSGLPATEIVWTHILPTAGGMVANQAQLFSQCLDYYLSEEGSGHLPEINRLAKENTPEADELLTRYFMEGARLRSSVALPRVAAQPTVVEDNGEKLTIKAGQVVMCNLVSACMDPTAFPDPEKVKLDRDMNLYAHFGFGPHKCLGLDLCKTGLSTMLKVLGRLDNLRRAPGAQGQLKKLSGPGGIAKYMNEDQSGFTPFPSTMKIQWDGELPQLKEDFHHHHHH